(19) United States
(12) Patent Application Publication
(10) Pub. No.: US 2026/0319677 A1
(43) Pub. Date: Oct. 15, 2026

(54) MEMORY CONTROLLER CIRCUIT TO ENABLE A PARTIALLY POWERED STATE IN A COMPUTING SYSTEM

(71) Applicant: Microchip Technology Incorporated, Chandler, AZ (US)

(72) Inventors: Steve Nagel, Chandler, AZ (US); Bomy Chen, Newark, CA (US)

(73) Assignee: Microchip Technology Incorporated, Chandler, AZ (US)

(21) Appl. No.: 19/271,366

(22) Filed: Jul. 16, 2025

Related U.S. Application Data
(60) Provisional application No. 63/788,603, filed on Apr. 14, 2025.

(51) Int. Cl. G06F 3/06

(52) U.S. Cl. CPC G06F 3/0625; G06F 3/0632; G06F 3/0673

(57) ABSTRACT

An integrated circuit device includes a first conductive contact to be conductively coupled to a first memory component and a second memory component of a plurality of memory components in a computing system, a second conductive contact to be conductively coupled to a first processing unit in the computing system, a memory controller circuit, and an embedded processor. The memory controller circuit is to cause first executable instructions received from the first processing unit to be stored in the first memory component and to cause the computing system to transition from a first power state to a second power state. During the second power state the second memory component and the first processing unit are to be powered down and the first memory component is to be powered up. The embedded processor is to execute the first executable instructions stored in the first memory component.

### CROSS-REFERENCE TO RELATED APPLICATION

This application claims the benefit of U.S. Provisional Patent Application No. 63/788,603, filed Apr. 14, 2025, which is incorporated herein by reference in its entirety.

### TECHNICAL FIELD

The present disclosure relates to computing systems and, more particularly, to a memory controller circuit that enables a partially powered state of a computing system.

### BACKGROUND TECHNICAL FIELD

The explosion of artificial intelligence (AI) has generated a massive demand for graphics processing units (GPUs), accelerated processing units (APUs), and other accelerators (XPUs) that typically use significant power resources and that can cause a battery to lose power quickly. Accelerators operate at high clock speeds to simultaneously run thousands of operations on many cores. Furthermore, accelerators often use fast memory such as high bandwidth memory (HBM), which also consumes more power.

As AI processing moves to the edge (e.g., Datacenter on Wheels, edge AI, drones, robots, etc.), preserving battery life has become increasingly important. Often such devices that incorporate AI processing run using smaller power sources such as batteries. The high power consumption of GPUs and other accelerators can quickly drain batteries and other small power sources. Additionally, the trajectory of the size of hardware to support AI applications in edge devices is trending downward, resulting in the use of smaller transistor nodes. Smaller transistor nodes are typically leakier than larger transistor nodes, which can drain power from the battery in the system. Consequently, the use of hardware with smaller and leakier transistor nodes exacerbates the problems associated with maintaining battery life.

Extending battery life is also important for systems with general purpose processing units, such as central processing units (CPUs). Such devices may utilize other types of memory and may drain battery power through transistors when applications run for extended periods or when many applications are running concurrently, for example.

### SUMMARY

The subject matter disclosed herein provides a hardware architecture with intelligence added to a local memory controller circuit that allows for powering down volatile memory components and processors, leaving a small number of memory components powered up, when an application is performing non resource-intensive functions. The powered up memory component may be used to store instructions for the non resource-intensive functions, which may include repetitive or simple instructions, and which may be executed by a low power processor embedded in an integrated circuit device with the memory controller circuit. When more resources are to be used by the application, the powered down memory components and processors can be quickly rebooted by boot firmware that is embedded in the memory controller circuit.

One example includes an integrated circuit device including a first conductive contact to be conductively coupled to a first memory component and a second memory component of a plurality of memory components in a computing system, a second conductive contact to be conductively coupled to a first processing unit in the computing system, a memory controller circuit, and an embedded processor. The memory controller circuit is to cause first executable instructions received from the first processing unit to be stored in the first memory component and to cause the computing system to transition from a first power state to a second power state. During the second power state the second memory component and the first processing unit are to be powered down and the first memory component is to be powered up. The embedded processor is to execute the first executable instructions stored in the first memory component. The memory controller circuit may also include non-volatile memory to store one or more firmware instructions that, when executed by at least one processing unit, cause the at least one processing unit to boot the first processing unit and cause the second memory component to be powered up. In more specific examples, the first processing unit is a graphics processing unit (GPU) and the plurality of memory components includes a stack of memory blocks of high bandwidth memory (HBM). In other specific examples, the first processing unit is a central processing unit (CPU) and the plurality of memory components includes an array of dual-inline memory modules (DIMM).

In another example, a system includes a memory, a first processing unit, and an integrated circuit device. The memory includes at least a first memory component and a second memory component. The integrated circuit device is conductively coupled to the first and second memory components, and to the first processing unit. When the memory and the first processing unit are powered up, the integrated circuit device is to cause the second memory component and the first processing unit to be powered down without powering down the first memory component, store first executable instructions received from the first processing unit in the first memory component, and execute the first executable instructions stored in the first memory component. In further examples, the integrated circuit device includes non-volatile memory to store one or more firmware instructions that, when executed by at least one processing unit, cause the at least one processing unit to boot the first processing unit and cause the second memory component to be powered up. In more specific examples, the first processing unit is a graphics processing unit (GPU) and the memory includes a stack of memory components of high bandwidth memory (HBM). In other specific examples, the first processing unit is a central processing unit (CPU) and the memory includes an array of dual-inline memory modules (DIMM).

### BRIEF DESCRIPTION OF THE DRAWINGS

FIG. 1 is a perspective view of an example high bandwidth memory (HBM) stack with an example memory controller circuit embedded in a base logic die of the HBM stack.

FIG. 2 is a block diagram illustrating example details of an integrated circuit device including a memory controller circuit for high bandwidth memory.

FIG. 3A is a cross-sectional view of a microelectronic assembly including selected components of a computing system in a fully powered state.

FIG. 3B is a cross-sectional view of the microelectronic assembly of FIG. 3A in which the computing system is in a partially powered state.

FIG. 4 is an example of a method for transitioning the computing system of FIGS. 3A-3B between a fully powered state and a partially powered state.

FIG. 5 is a block diagram illustrating example memory modules with an example integrated circuit device including a memory controller circuit for the memory modules.

FIG. 6A is a block diagram illustrating a top view of selected components in a computing system including memory modules and an integrated circuit device in a fully powered state.

FIG. 6B is a block diagram illustrating a top view of the computing system of FIG. 6A in a partially powered state.

FIG. 7 is an example of a method for transitioning the computing system of FIGS. 6A-6B between a fully powered state and a partially powered state.

FIG. 8 is a block diagram of an example computing system that may be used in accordance with any examples disclosed herein.

### DETAILED DESCRIPTION

The present disclosure provides various possible examples of systems, methods, machine readable media, and apparatuses related to a smart memory controller (also referred to herein as a “memory controller circuit”) configured to enable a low power sleepwalking state (also referred to herein as a “partially powered state”) in a computing system. The memory controller circuit facilitates the transition of the computing system between a fully powered state and a partially powered state as a type of operations to be performed and resource needs change for an application running on processor configured to access memory that includes multiple memory components.

Many applications today use significant compute power when performing intensive tasks. For example, autonomous robotic systems such as drones, eDrones, eDogs (e.g., robotic pets), eFish, humanoid robots, industrial personal computers, industrial desktop computers, and industrial services may perform real-time computer vision and vision processing, autonomous movement, speech recognition and natural language processing, body motion, decision-making, cloud connectivity and data transfer, and more. Such tasks can involve artificial intelligence including machine learning models (e.g., convolutional neural networks (CNN), artificial neural networks (ANN), etc.) used in software workloads that demand intense compute power and fast memory accesses. In many systems involving AI or other intensive compute tasks, high bandwidth memory (HBM) is used to allow high speed memory accesses and sufficiently sized data transfers.

Although autonomous robotic systems and other resource-intensive systems can use enormous compute power to perform certain tasks, much of the time in service for these systems involves performing other tasks that use fewer compute resources. The ability to selectively power down memory components one or more processing units when a system is not performing resource-intensive tasks can significantly increase battery life and also the range of the battery, if applicable.

Applications running on general-purpose systems (e.g., CPUs) or specialized systems that use other types of memory (e.g., unstacked memory modules) may also spend a significant amount of time performing repetitive tasks or other low power tasks that use fewer resources. Extending battery life for such is also desirable for these systems. Selectively powering down memory components and potentially one or more processing units of the computing system can significantly increase the battery life.

A hardware architecture in the form of an integrated circuit device including an embedded smart memory controller circuit to enable a partially powered state in a computing system, as described herein, can resolve these issues (and more). For example, a computing system with at least one accelerator (e.g., GPU, APU) may include memory designed for high-speed data transfer, such as high bandwidth memory (HBM) that includes multiple memory blocks and a logic die arranged as layers of an HBM stack. The logic die may be embodied as a discrete integrated circuit device configured to manage memory access across the stacked memory layers and including a memory controller circuit that is configured with intelligence to enable a partially powered state (also referred to herein as an “auto-pilot mode”) in the computing system. In the partially powered state, selected memory blocks (e.g., volatile memory blocks in the HBM stack) and processors such as one or more accelerators (e.g., GPU, APU) and potentially one or more other processors (e.g., central processing unit (CPU)) are powered down (or shut down). The partially powered state can be enabled when the computing system performs non resource-intensive functions. The powered down memory blocks and processors can be powered up again when the computing system performs more resource-intensive functions that request or use the resources (e.g., compute, memory, power, network, etc., or any combination thereof) that were powered down. A memory controller circuit for enabling a partially powered state may include embedded boot firmware (e.g., Basic Input/Output System (BIOS), video BIOS, Unified Extensible Firmware Interface (UEFI), etc.), detection memory (e.g., a special presence detect (SPD) circuit), and a programmable lookup table. The memory controller circuit allows one or more processors and one or more memory blocks to be powered down to create an ultra low power mode in the partially powered state.

In another example, a computing system may include general-purpose memory that allows at least some data transfers without utilizing a high bandwidth, such as Dual Inline Memory Module (DIMM). An integrated circuit device may be communicatively coupled to memory modules of the general-purpose memory and may include a combination of components for managing access across the memory modules. The integrated circuit device may also include a memory controller circuit for enabling a low power sleepwalking state (also referred to herein as a “partially powered state”) in the computing system. In the partially powered state, selected memory modules (e.g., volatile memory modules in the DIMM arrays) and one or more processors (e.g., CPU) and potentially other processor (e.g., one or more accelerators)s are powered down (or shut down). The partially powered state can be enabled when the computing system performs non resource-intensive functions. The powered down memory modules and processors can be powered up again when the computing system performs more resource-intensive functions that request or use the resources (e.g., compute, memory, power, network, etc., or any combination thereof) that were powered down. An integrated circuit device for accessing memory modules and enabling a partially powered state may include a low power embedded processor, an embedded registered clock driver (RCD), a power management integrated circuit (PMIC), and a memory controller circuit that includes boot firmware, detection memory (e.g., a serial presence detect (SPD) circuit),, and a programmable lookup table. The memory controller circuit allows one or more processors and one or more memory modules to be powered down to create an ultra low power mode in the partially powered state.

Creating an integrated circuit device with a memory controller circuit by adding intelligence to a logic die of high bandwidth memory (e.g., HBM stack), or by integrating several components and intelligence to manage other memory (e.g., DIMM arrays), allows for enabling a partially powered state when non resource-intensive system resources are used by an application and then booting up again when more (or all) system resources are to be used by the application. The location of the memory controller circuit may be close to memory (e.g., local to the memory such as being located at the bottom of an HBM stack, between memory modules of DIMM arrays, etc.) that is partially powered down during the partially powered state. The memory controller circuit's proximity to memory allows instant or very fast waking of the powered down components that is a quicker waking than a typical boot performed by boot firmware that is located on a separate chip or integrated in a processor package. Advantageously, this can save power for the computing system by reducing power consumption and can extend the range in battery-powered applications.

Reference is now made to the drawings, which are not necessarily drawn to scale. Similar or the same numbers may be used to designate the same or similar parts in different figures. The use of similar or the same numbers in different figures does not mean all figures including similar or the same numbers constitute a single example of the subject matter disclosed herein. Like numerals having different letter or number suffixes may represent different instances of similar components. The drawings illustrate generally, by way of example, but not by way of limitation, various aspects of the subject matter discussed in the present document.

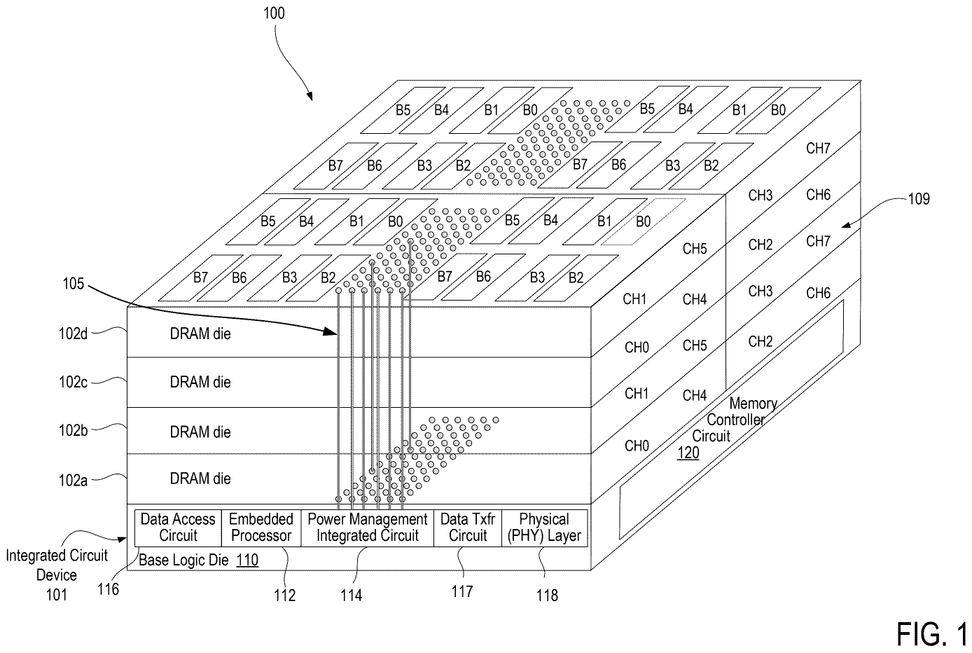

FIG. 1 is a perspective view of a high bandwidth memory (HBM) stack 100 with a base logic die 110 and a plurality of memory components that are in a layered arrangement above the base logic die 110. The base logic die 110 may be fabricated on a semiconductor substrate and contain various integrated circuit components that may include, but are not limited to a memory controller circuit 120, a low power processor 112, a power management integrated circuit (PMIC) 114, a data access circuit 116, a data transfer circuit 117, and a physical (PHY) layer 118. The base logic die 110 may be an integrated circuit device 110 that, when conductively coupled to a computing system with at least one processor, is capable of performing state transition functions between a fully powered state and a partially powered state, memory accesses across the layered memory components, some computational functions, and boot functions for components that are powered down in the partially powered state. In an example the integrated circuit device 110 may be integrated into a multi-die memory package, such as an HBM stack (e.g., HBM stack 100). In other scenarios, the integrated circuit device 110 may be conductively coupled to, but separate from the layered memory components.

The HBM stack 100 may be implemented in a computing system that provides accelerated computing with one or more processors that perform fast and efficient calculations (e.g., GPUs, APUs, etc.). Nonlimiting examples of such computing systems include, but are not limited to, autonomous robotic systems (e.g., drones, eDrones, eDogs, eFish, robotic pets, etc.), humanoid robots, and industrial PCs, desktops, laptops, and servers.

In the HBM stack 100 of FIG. 1, the memory components are arranged as four layers of memory blocks, where each memory block includes a dynamic random access memory (DRAM) die. In other examples, two, three, five, six, or more memory components could form the memory layers of an HBM stack. The memory components in an HBM stack may also be referred to herein as “memory blocks” or “memory layers” or “layers of memory blocks.”

The four layers of memory blocks in FIG. 1 include DRAM die 102a, DRAM die 102b, DRAM die 102c, and DRAM die 102d. DRAM die 102a is the closest DRAM die to the base logic die 110. The individual DRAM dies may include multiple memory channels 109 (e.g., CH0, CH1, CH2, CH3, CH4, CH5, CH6, CH7) that are horizontal input/output pathways to provide parallel data pathways between the base logic die 110 and the DRAM dies 102a-102d. The DRAM dies may also be divided into multiple banks (e.g., B0, B1, B2, B3, B4, B5, B6, B7) that are vertical layers in the HBM stack and allow for parallel access to the DRAM dies 102a-102d.

Multiple through silicon vias (TSVs) 105 extend vertically from the DRAM layers to the PMIC 114 from which power can be supplied to the DRAM dies 102a-102d. The PMIC 114 can distribute power to the memory blocks and also other components in the base logic die 110. For example, PMIC 114 can provide power to the embedded processor 112 during the partially powered state and can power down the embedded processor 112 when the low power processor is not needed. For example, the lower power processor 112 may be powered down during the fully powered state in at least some scenarios.

Some TSVs 105 can connect banks (e.g., B0-B7) and memory channels (e.g., CH0-CH7) vertically to the base logic die 110 to provide conductive pathways to allow data (including executable instructions) to be read from the memory blocks or written to the memory blocks. Thus, at least some of the TSVs may be used to carry data to and from the DRAM dies 102a-102d.

A data access circuit 116 is included in the base logic die 110 to facilitate input/output of data across the DRAM dies 102a-102d, which is sent to or received by one or more processors or a main memory controller in the computing system. The data access circuit 116 may manage and control the read and write operations of the stacked DRAM dies 102a-102d via the TSVs 105. When the computing system is in a partially powered state, the data access circuit may manage and control the read and write operations of the one powered on memory block (e.g., DRAM die 102a) and other powered on memory blocks, if any. The data access circuit 116 may include various components (e.g., channel controllers, address decoders, PHY interface for the DRAM dies, and access control logic) to perform the managing and control functions for read and write operations of the stacked DRAM dies.

The base logic die 110 also includes a physical (PHY) layer 118. The PHY layer 118 is an electrical interface that can be used to conductively couple the base logic die 110 with other components in a computing system, such as a graphics processing unit (GPU), an accelerated processing unit (APU), another accelerator, a central processing unit (CPU), a system-on-a-chip (SOC), one or more other processors, one or more other components, or any suitable combination thereof. In some examples, the PHY layer 118 can conductively couple the base logic die 110 to a main memory controller in the computing system, where the main memory controller may be integrated with a processor, implemented as a separate die on a circuit board, or provided in any other suitable device or element of the computing system. The data transfer circuit 117 may control high-speed data transfers between the base logic die 110 and the main memory controller. The PHY layer 118 is also conductively coupled to the TSVs 105 that are used to carry data signals to and from the DRAM dies 102a-102d.

The base logic die 110 also includes a low power processor 112. The low power processor may be configured to execute code when the computing system is in a partially powered state and the accelerator (e.g., GPU, APU) is powered down. The low power processor enables the execution of certain code associated with an application being executed by the accelerator. Such code may be repetitive or simple executable instructions that do not require the compute power of the accelerator.

In this example, the base logic die 110 further includes a memory controller circuit 120. The memory controller circuit 120 may be embodied as an embedded boot-detect logic die with a programmable lookup table (LUT). The memory controller circuit 120 may include boot firmware such as a basic input/output system (BIOS), a video BIOS, a unified extensible firmware interface (UEFI), or any other suitable firmware that facilitates initialization and configuration of hardware during a boot process. The memory controller circuit 120 may further include detection memory (e.g., serial presence detect (SPD)) configured as hardware, firmware, or both hardware and firmware to store information about the memory blocks (e.g., DRAM dies 102a-102d) that enables detection and configuration of the memory blocks by the boot firmware. In one nonlimiting example, detection memory may be implemented as an electrically erasable programmable read only memory (EEPROM).

The memory controller circuit 120 may also include a lookup table or LUT that includes programmable hardware (e.g., a small central processing unit (CPU) or field programmable gate array (FPGA)). In one example, the LUT may be programmed with intelligence to determine whether one or more conditions have been met to transition the computing system from a fully powered state to a partially powered state or to transition the computing system from the partially powered state to the fully powered state. The LUT may be programmed to enable the embedded processor 112 to retrieve instructions stored in a selected one or more of the DRAM dies that remain powered up when the computing system is in the partially powered state, and to execute the instructions while the computing system is in the partially powered state. The LUT may also be programmed to include initialization information for the one or more processors (e.g., GPU, CPU, etc.) that are powered down when the computing system is in the partially powered state. In other examples, one or more of the components of the memory controller circuit may be implemented on separate dies within the integrated circuit device or separate from the integrated circuit device.

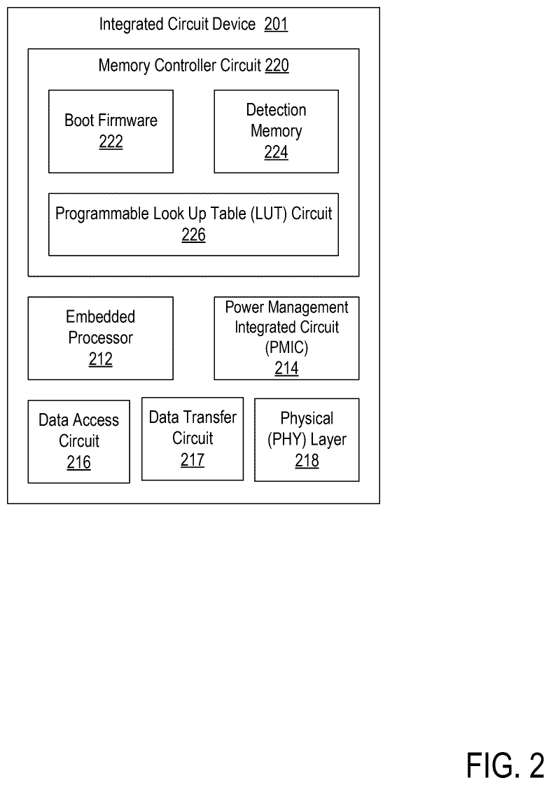

FIG. 2 is a block diagram illustrating example details of an integrated circuit device 201 including a memory controller circuit 220 for high bandwidth memory components, which may be similar to memory components in HBM stack 100 of FIG. 1. The integrated circuit device 201 illustrates one possible configuration of the integrated circuit device 101 of FIG. 1. The integrated circuit device 201 can include the memory controller circuit 220, an embedded processor 212, a power management integrated circuit (PMIC) 214, a data access circuit 216, a data transfer circuit 217, and a PHY layer 218. The memory controller circuit 220 illustrates one example of the memory controller circuit 120 of FIG. 1. The memory controller circuit 220 may include boot firmware 222, detection memory 224, and a programmable lookup table (LUT) circuit 226.

The boot firmware 222 can include, for example, BIOS, video BIOS, UEFI, or any other suitable firmware that facilitates initialization and configuration of hardware during a boot process. Typically, boot firmware is provided in a video card, a processor, or a separate chip. Embedding the boot firmware 222 in the integrated circuit device 201 allows for selected resources of a computing system to be powered up quickly when the computing system is transitioning from a partially powered state to a fully powered state. In one or more examples, the transition may be prompted based on one or more conditions for transitioning to a fully powered state. The one or more conditions for transitioning to a fully powered state may be predefined or dynamically determined as further described below.

The boot firmware may be configured to perform a full boot that is similar to powering up a computing system from a shut down state or a partial boot that is similar to powering up a computing system from a hibernation state. For a partial boot configuration, when the computing system is transitioned to the partially powered state, system state (e.g., for processors, memory, and the like) is saved for use by the boot firmware 222 to subsequently transition the computing system to the fully powered state. The state may be saved in any suitable memory (e.g., detection memory 224, LUT circuit 226, powered up memory component 102a).

The detection memory 224 enables detection and configuration of memory blocks (e.g., DRAM dies of high bandwidth memory) by the boot firmware 222. In one nonlimiting example, the detection memory 224 may include, for example, a serial presence detect (SPD) circuit that stores configuration information about the associated high bandwidth memory (e.g., speed, timings, voltage, capacity) and allows the boot firmware 222 (e.g., BIOS, video BIOS, UEFI, etc.) to access and obtain the configuration information to configure memory settings and initialize the memory channels during the boot process. Because the detection memory 224 and the boot firmware 222 are embedded in the same integrated circuit device 201 (e.g., a base logic die of an HBM stack), the configuration information stored by the detection memory 224 can be accessed quickly to enable a faster transition from a partially powered state to a fully powered state than a typical boot process that might communicate with an SPD circuit over a serial interface bus or other data pathway.

The LUT circuit 226 may include programmable hardware that is programmed with intelligence by an accelerator executing an application in the computing system. In at least one example, the accelerator (or another processing unit or component in the computing system) may determine that one or more conditions have been met to prompt a transition in the computing system from a fully powered state to a partially powered state. In some examples, the accelerator may provide code to the LUT circuit 226 to enable the LUT circuit to determine that one or more conditions have been met to prompt a transition in the computing system from a fully powered state to a partially powered state. Once the one or more conditions have been detected, the accelerator may provide code (e.g., executable instructions) to the LUT circuit 226 to enable the LUT circuit to transition the computing system from a fully powered state to a partially powered state, to store sleepwalking code (e.g., which may be executable instructions that are repetitive, simple, routine, non-resource intensive, or the like, or any combination thereof) to be executed during the partially powered state, and to perform memory controller functions for the processor (e.g., embedded processor 212) that executes the sleepwalking code.

The accelerator may also provide code to enable the LUT circuit to detect one or more other conditions to prompt a transition in the computing system from the partially powered state to the fully powered state, and to cause embedded boot firmware 222 to be executed based on detecting the one or more other conditions. In other examples, the embedded processor (e.g., embedded processor 212) executing the sleepwalking code may contain hardcoded instructions to detect the one or more other conditions to prompt a transition in the computing system from the partially powered state to the fully powered state and to cause the boot firmware 222 to be executed.

In one example, the LUT circuit 226, which may have functionality that is similar to a small field programmable gate array (FPGA) or other small circuit that is capable of storing and executing instructions received from an accelerator, such as a GPU. The LUT circuit 226 may be configured based on a Resistive Random Access Memory (ReRAM), which is a type of non-volatile memory that stores data by changing the resistance of solid-state material. Examples of ReRAM that may be used include, but are not necessarily limited to, 22 nanometer ReRAM or 12 nanometer ReRAM. In other examples, the LUT circuit 226 may be configured based on a Magnetoresistive Random Access Memory (MRAM), a Phase-Change Random Access Memory (PCRAM), or any other suitable non-volatile memory.

Embedding an ReRAM-based (or an MRAM-based, PCRAM-based, or any other suitable non-volatile memory-based) LUT circuit 226, boot firmware 222, and detection memory 224 in a base logic die (e.g., to produce integrated circuit device 201) of layered memory blocks (e.g., DRAM dies 102a-102d of HBM stack 100) allows for selected resources of a computing system to be powered down while code is executing based on detected conditions for transitioning to a partially powered state. The conditions may be predefined or dynamically determined. In at least one example, most (but not all) of the compute and memory resources may be powered down when such resources are not being used and then quickly booted again when the resources are to be used. For example, embedding the memory controller circuit 220 with the ReRAM-based LUT circuit 226, boot firmware 222, and detection memory 224 in a base logic die (e.g., base logic die 110) can produce an integrated circuit device (e.g., integrated circuit device 201, 101) that allows accelerators (e.g., GPU, APU, XPU) and other processors (e.g., CPUs), which may have leaky transistors, and at least some (but not all) of the memory blocks of a memory stack (e.g., DRAM dies in an HBM stack) to be powered down when an application is performing repetitive, simple, or routine functions or tasks, and then powered up again when the instructions to be executed are more complex and may use more compute and memory resources. One or more (or all) other components of a computing system may also be powered down in the partially powered state, or alternatively, one or more (or all) other components may remain powered up in the partially powered state.

Generally, when a component (e.g., accelerator, processor, memory block, memory component, memory module, DRAM die, integrated circuit device, or any other part or device of a computing system that receives electrical power to perform its intended function) is powered down, the component is no longer supplied with electrical current and is rendered electrically inactive. When a component is powered up, the component is supplied with sufficient electrical current to render the component electrically active and operable.

The embedded processor 212 (e.g., similar to embedded processor 112) may be any suitable processing unit that is embedded in the integrated circuit device 201 and that can execute simple, repetitive, or routine tasks or functions. Embedded processor 212 may be a low power processor that is configured to consume less power than a typical CPU, GPU, or other similar higher power processing units. Such tasks or functions may use the same or less compute resources than a compute resources threshold, the same or less memory resources than a memory resources threshold, the same or less power resources than a power resources threshold, or any combination thereof. In a non-limiting example, the embedded processor 212 may be a small, low power processor including, but not limited to M0 Little, which is an ARM® processor in the Cortex®-M family of processors, or a CPU that implements Reduced Instruction Set Computer (RISC) architecture.

The PMIC 214 may be similar to PMIC 114 of FIG. 1. The PMIC 214 can provide power to layered memory blocks (e.g., DRAM dies 102a-102d) using TSVs (e.g., TSVs 105) that extend vertically through the layered memory blocks. When the computing system is in a fully powered state, the PMIC 214 can provide power (or cause power to be provided) to the layered memory blocks. When the computing system transitions to the partially powered state, the PMIC 214 may receive a signal from the LUT circuit 226 and, in response to receiving the signal from the LUT circuit 226, selectively power down one or more of the memory blocks, while leaving at least one memory block powered up. In at least some scenarios, a single memory block remains powered up during the partially powered state. It should be noted, however, that in other scenarios, two, three, four, or more memory blocks (but not all memory blocks) remain powered up during the partially powered state. The number of memory blocks that remain powered up may be predetermined or dynamically determined depending on the particular code that is to be executed during the partially powered state.

The data transfer circuit 217 may be similar to the data transfer circuit 117 of FIG. 1. The data access circuit 216 may be similar to the data access circuit 116 of FIG. 1. The PHY layer 218 may be similar to the PHY layer 118 of FIG. 1.

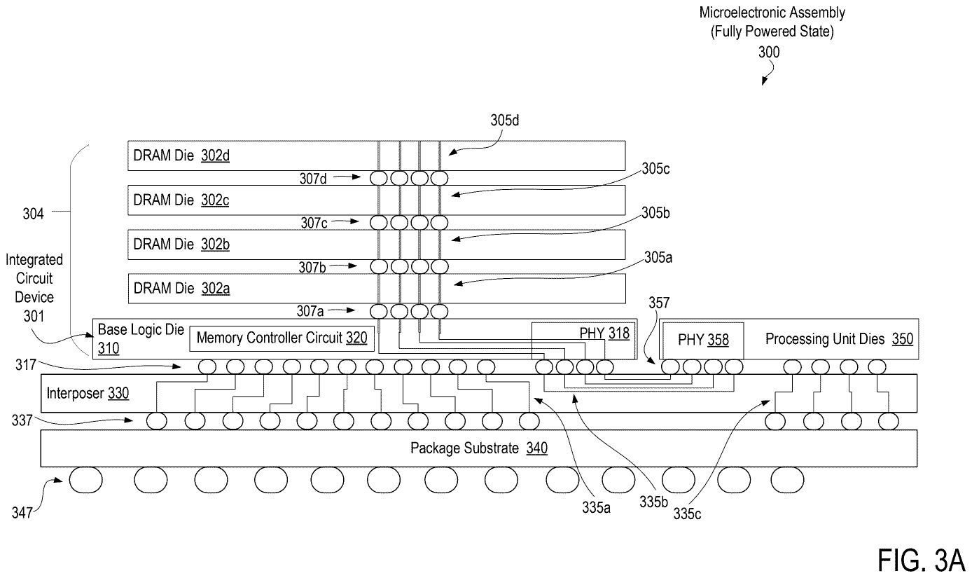

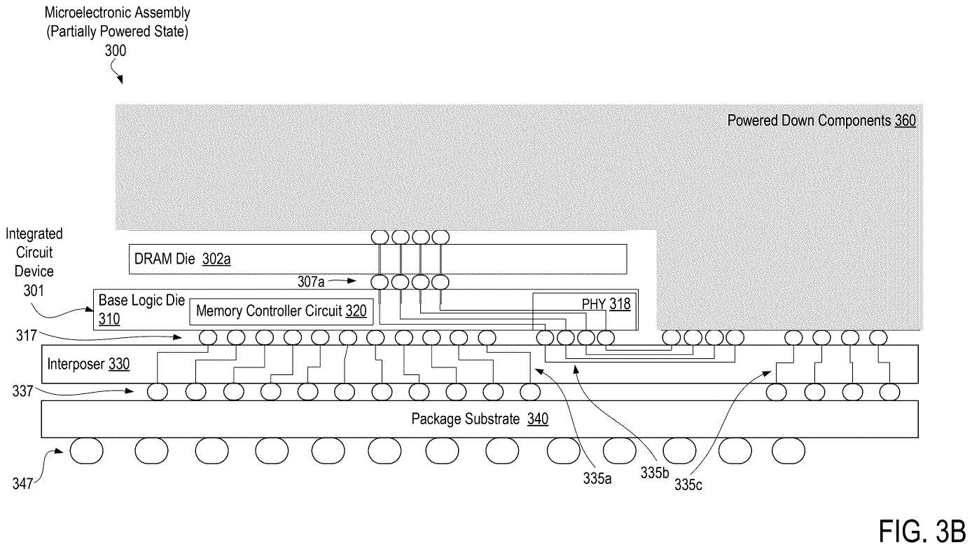

FIGS. 3A and 3B together illustrate the transition in a computing system with high bandwidth memory and an accelerator from a fully powered state to a partially powered state according to the present disclosure. FIG. 3A is a cross-sectional view of a microelectronic assembly 300 that includes selected components of a computing system in a fully powered state according to at least one example.

The microelectronic assembly 300 includes an HBM stack 304 (e.g., similar to HBM stack 100 in FIG. 1). The HBM stack 304 is a multi-die memory package with a base logic die 310 (e.g., similar to base logic die 110 of FIG. 1). The HBM stack 304 includes four layers of memory blocks including DRAM die 302a, DRAM die 302b, DRAM die 302c, and DRAM die 302d. The base logic die 310 includes a memory controller circuit 320 (e.g., similar to memory controller circuit 120 of FIG. 1 or memory controller circuit 220 of FIG. 2). The base logic die 310 may be an integrated circuit device 301 (e.g., similar to integrated circuit devices 101, 201) capable of performing control and coordination functions, including memory accesses, across the stacked memory layers, and further capable of performing some computational functions and boot functions. In this example, the integrated circuit device 301 is integrated into the HBM stack 304. In other scenarios, the integrated circuit device 301 may be conductively coupled to, but separate from the layered DRAM dies 302a-302d.

TSVs 305a, 305b, 305c, and 305d and microbumps 307a, 307b, 307c, and 307d between the DRAM dies and between the lowest DRAM die 302a and the base logic die 310 provide various electrical pathways between the base logic die 310 and the DRAM dies 302a-302d. In addition, horizontal traces or lines may be formed in each of the DRAM dies 305a-305d and base logic die 310 to route electrical signals between electronic components within the dies. It should be noted that “microbumps” may be embodied as conductive contacts or conductive pads that are used to conductively couple layers (e.g., DRAM dies 302a-302d, base logic die 310, interposer 330, package substrate 340, processing unit dies 350) of an integrated circuit package and a microelectronic assembly.

The microelectronic assembly 300 further includes an interposer 330 conductively coupling the base logic die 310, one or more processing unit dies 350, and a package substrate 340 by microbumps 317, 337, and 357 and by interposer vias or interconnects 335a, 335b, and 335c. The package substrate includes microbumps 347 on a lower surface, which may be used to conductively couple the selected components of the microelectronic assembly 300 (and possibly other components not shown) to other integrated circuit packages, microelectronic assemblies, or a combination thereof of the computing system or other computing systems. In at least some scenarios, the package substrate may be conductively coupled to a motherboard of the computing system via microbumps 347.

The microelectronic assembly 300 further includes one or more processing unit dies 350, such as one or more GPUs, one or more CPUs, one or more systems-on-a-chip (SoC), one or more other accelerators, other types of processors, or any suitable combination thereof. The one or more processing unit dies 350 include a PHY layer 358 that is conductively coupled to the PHY layer 318 of the base logic die 310 by interposer vias or interconnects 335b formed through interposer 330, microbumps 317 connecting first ends of the interposer vias or interconnects 335b to the base logic die 310, and microbumps 357 connecting second ends of interposer vias or interconnects 335b to the one or more processing unit dies 350. The one or more processing unit dies 350 may also be conductively coupled to other components of the computing system through the interposer 330 and package substrate 340 by interposer vias or interconnects 335c, microbumps 357 connecting first ends of the interposer vias or interconnects 335c to the one or more processing unit dies 350, microbumps 337 connecting second ends of the interposer vias or interconnects 335c to the package substrate 340, substrate vias or interconnects (not shown) connecting the microbumps 337 to microbumps 347, and lines, traces, or any other suitable conductive pathway connecting the microbumps 347 to other components of the computing system or other computing systems. It should be apparent that the microelectronic assembly shown in FIGS. 3A and 3B is one possible configuration and the subject matter disclosed herein but may be implemented in any number of other microelectronic assembly configurations including additional (or fewer) components, dies, interposers, interconnects, vias, TSVs, lines or traces, microbumps.

In FIG. 3A, the computing system in which the microelectronic assembly 300 is implemented is illustrated being in a fully powered state. When the computing system is in a fully powered state, a boot process has previously been completed such that the HBM stack 304 and the one or more processors on the one or more processing unit dies 350 are powered up. In an example, the computing system may remain in a fully powered state when the computing system is performing resource-intensive tasks or functions that use more than a compute resources threshold, more than a memory resources threshold, more than a power resources threshold, or any suitable combination thereof.

In one nonlimiting example, a computer video game may include code (e.g., one or more executable instructions) that, when executed, uses more than a compute resources threshold, a memory resources threshold, a power resources threshold, or a combination thereof during gameplay (e.g., user interactions involving fighting, using weapons, driving automobiles or boats, flying planes, or engaging in any other similar activities). In another nonlimiting example, drones may include code that, when executed, use more than a compute resources threshold, a memory resources threshold, a power resources threshold, or a combination thereof while actively moving (e.g., horizontally, diagonally, vertically, etc.) through the air. In these scenarios, based on the compute resources, memory resources, power resources, or combination thereof, the computing system remains in a fully powered state during the execution of code to perform the described activities.

FIG. 3B is a cross-sectional view of the microelectronic assembly 300 of FIG. 3A when the computing system is in a partially powered state. When the computing system is in the fully powered state, an instruction pointer of a processor (e.g., GPU on one of the processing unit dies 350) typically points to a next instruction in code to be executed. The instruction may be the start of a set of executable instructions that meet one or more conditions that cause the memory controller circuit 320 to transition the computing system from a fully powered state shown in FIG. 3A to a partially powered state (also referred to herein as a “sleepwalking state”) shown in FIG. 3B. Examples of conditions that could prompt the transition from a fully powered state to a partially powered state may include one or more of (1) a resource (e.g., compute, memory, power) usage level by code to be executed is below a first threshold, (2) a period for the code to be executed exceeds a time threshold, (3) a first number of repeated instructions in the code to be executed exceeds a first number threshold, (4) a second number of repeated sets of instructions in the code to be executed exceeds a second number threshold, (5) input received from a user indicating that code to be executed is to be executed in the sleepwalking state, or (6) the code to be executed is a known function identified a priori as suitable for execution in the sleepwalking state.

Code that is to be executed and that meets one or more conditions including, but not necessarily limited to the conditions outlined above, is also referred to herein as “sleepwalking code.” It should be noted that an application may include one, two, three, or more portions of sleepwalking code that cause the computing system to transition to the partially powered state during which the particular sleepwalking code of the application can be executed. Sleepwalking code may include one or more sets of instructions in an application, a function (e.g., user defined function, library function, function-as-a-service (FaaS) or module invoked by the application, a microservice, code that is generated on the fly by a processor, or a suitable combination thereof. In some examples, sleepwalking code may be generated on the fly by a processor based on particular user inputs, sensor inputs, code, conditions, or a suitable combination thereof.

Generally, sleepwalking code can include any type of instructions that can be executed by a type of processor that can be embedded in the base logic die 310 and uses less power and other resources than the power and other resources used by the main processor executing the application(s) from which the sleepwalking code is derived, generated, or otherwise obtained. In at least some examples, the sleepwalking code may include simple instructions, repetitive instructions, routine instructions, non resource-intensive instructions, or any combination thereof. In one nonlimiting example, a computer video game may include code that, when executed, does not meet a threshold level of compute, memory, or power resources, or a combination thereof such as when the video game combatants walk, march, sit, move from point A to point B, or remain still for surveillance. In another example, code that is executed to cause a drone to remain still for surveillance over a given period may be capable of being executed without access to maximum resources that are available in a fully powered state. Such activities in a video game or drone may use a smaller amount of memory, compute, and power resources as the code to perform the activities may include simple, repetitive, routine, or non resource-intensive instructions.

In some examples, the memory controller circuit 320 of the integrated circuit device 310 in the HBM stack 304 may ping the GPU (or other accelerator that is executing an application and accessing the HBM stack 304) to request sleepwalking code. In this example, the memory controller circuit 320 may detect one or more conditions in the computing system. When one or more conditions are detected, the memory controller circuit 320 may send a request to the GPU for sleepwalking code and other executable instructions to enable the memory controller circuit 320 (e.g., LUT circuit 220 of FIG. 2) to transition the computing system to a partially powered state.

In other examples, the GPU may detect one or more conditions in the computing system that are suitable for transitioning the computing system to the partially powered state. Once the GPU detects the one or more conditions, the GPU may provide the sleepwalking code and other executable instructions to the memory controller circuit 320 to trigger the memory controller circuit 320 (e.g., LUT circuit 220 of FIG. 2) to transition the computing system to the partially powered state.

Once the sleepwalking code and the other executable instructions have been received by the memory controller circuit 320, the memory controller circuit 320 stores the sleepwalking code in one of the memory components of HBM stack 304 that is to remain powered up in the partially powered state. The memory controller circuit 320 executes at least some of the other executable instructions received from the GPU to transition the computing system from a fully powered state as shown in FIG. 3A to a partially powered state as shown in FIG. 3B.

During a partially powered state, multiple components in the microelectronic assembly 300 are powered down and a few components remain powered up to allow the sleepwalking code to be executed. In this example, the components that are powered down during a partially powered state include the upper memory blocks of the HBM stack (e.g., DRAM dies 302b, 302c, and 302d) and the one or more processors on the processing unit dies 350. For example, if the processing unit dies 350 include a CPU and an accelerator such as a GPU that is executing an application from which sleepwalking code is derived, generated, or otherwise obtained, then the GPU may be powered down after the sleepwalking code is provided to the memory controller circuit 320. In addition, the CPU may also be powered down once the sleepwalking code is provided to the memory controller circuit 320. For illustration purposes, the powered down components are hidden and referenced as powered down components 360 in FIG. 3B.

When the computing system is transitioned to the partially powered state, a portion of the integrated memory (e.g., the lowest memory block such as DRAM die 302a) can remain powered up along with a low power processor (e.g., similar to embedded processor 112 of FIG. 1 or embedded processor 212 in FIG. 2) embedded in the base logic die 310. The higher level memory blocks (e.g., DRAM dies 302b-302d) can be powered down or shut down, for example, by a power management integrated circuit (e.g., similar to PMIC 114 of FIG. 1 or PMIC 214 of FIG. 2) in the base logic die 310. In other examples, two or more memory blocks may remain powered up in the partially powered state.

The sleepwalking code can be stored in the memory block that remains powered up (or across two more memory blocks if more than one memory block remain powered up). In the example shown in FIG. 3B, DRAM die 302a remains powered and therefore, the sleepwalking code can be stored in the one powered up memory block, DRAM die 302a.

In some examples, as shown in FIG. 3B, the lowest layer memory block remains powered up because of the close proximity to the base logic die 310 and resulting shorter electrically conductive pathways for data to travel in the partially powered state. In other examples, however, a different memory layer or layers (e.g., second, third, fourth or higher memory block) may remain powered up in the partially powered state. Any one or more of the memory blocks that remains powered up in the partially powered state may be used to store data, which is inclusive of executable instructions, that is accessed by the base logic die 310 to execute the sleepwalking code.

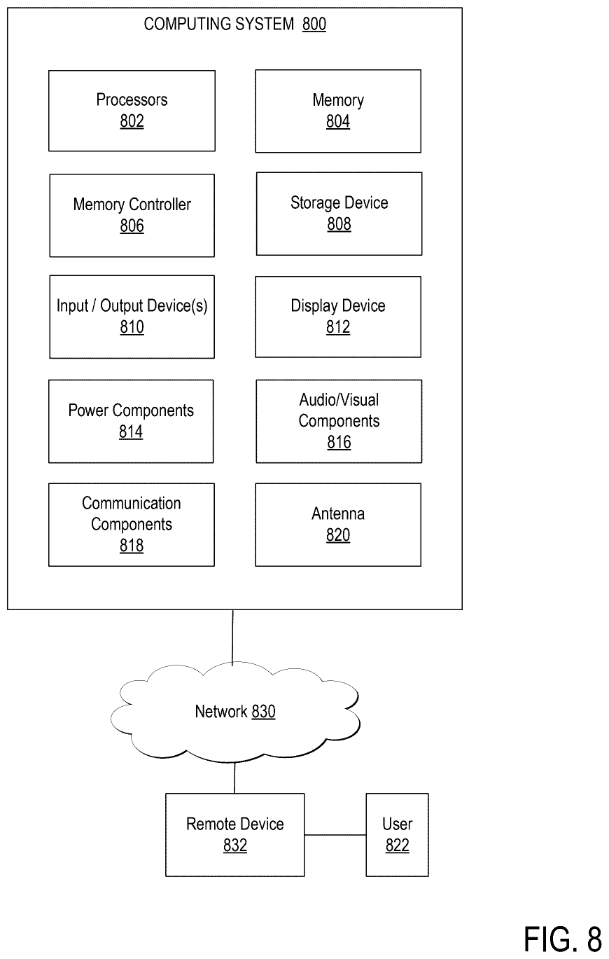

The memory controller circuit 320 can provide an appropriate signal to cause the one or more processors on the processing unit dies 350 to be powered down for the partially powered state. For example, a LUT circuit (e.g., LUT circuit 226 in FIG. 2) of the memory controller circuit 320 can provide a signal to cause a power management integrated circuit (PMIC) in the computing system (e.g., power components 814 in FIG. 8) to power down the one or more processors in the processing unit dies 350. Alternatively, the LUT may provide a signal to the power management integrated circuit (e.g., PMIC 114 in FIG. 1 or PMIC 214 in FIG. 2) of the base logic die 310 to communicate with the PMIC or other appropriate component in the computing system to power down the one or more processors.

Once the selected DRAM dies and one or more processors are powered down to allow the computing system to enter the partially powered state, and the sleepwalking code is stored in the powered up memory block (e.g., DRAM die 302a), the embedded processor (e.g., embedded processor 212) in the base logic die 310 can execute the instructions of the sleepwalking code stored in the powered up memory block (or memory blocks if more than one memory block remains powered up and are used to store at least a portion of the sleepwalking code). In some examples, a LUT circuit (e.g., LUT circuit 226 of FIG. 2) may perform memory controller functions for the embedded processor (e.g., embedded processor 112 of FIG. 1 or embedded processor 212 of FIG. 2) to perform memory accesses to fetch instructions of the sleepwalking code from the powered up memory block (e.g., DRAM die 302a), or to read or store other data in the powered up memory block.

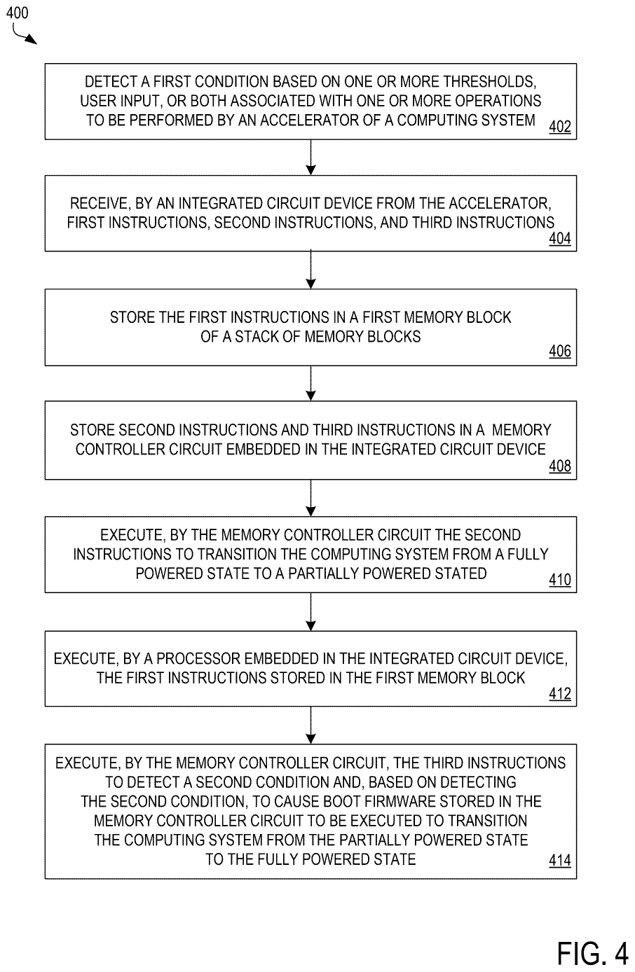

FIG. 4 is an example of a method 400 for transitioning a computing system with a microelectronic assembly (e.g., microelectronic assembly 300 of FIGS. 3A-3B) between a fully powered state and a partially powered state (or sleepwalking state). The microelectronic assembly may include a memory controller circuit (e.g., memory controller circuit 120, 220, 320) embedded in a base logic die (e.g., base logic die 110, 310) of an integrated circuit device (e.g., integrated circuit device 101, 201, 301). The integrated circuit device may form a bottom layer of a memory stack (e.g., HBM stack 100, 304) and be conductively coupled to an accelerator, such as a GPU. In one or more examples, at least some of the operations of method 400 may be performed (or caused by) various components of the integrated circuit device.

At 402, a first condition may be detected based on one or more thresholds or user input or both associated with one or more operations (e.g., in the form of executable instructions, functions, software modules, code generated on the fly, or tasks) to be performed by an accelerator, such as a GPU for example, of a computing system. Generally, the one or more operations correspond to sleepwalking code, as previously described herein. In some scenarios, the accelerator may detect and evaluate the first condition. In other scenarios, the accelerator may provide one or more executable instructions to a LUT circuit (e.g., LUT circuit 526) in the integrated circuit device to enable the LUT circuit to detect and evaluate the first condition. In yet other scenarios, another processor or other component in the computing system may detect and evaluate the first condition.

At 404, first instructions, second instructions, and third instructions are received by the integrated circuit device from the accelerator. The first, second, and third instructions may be combined or separated in any suitable manner. The first instructions (e.g., sleepwalking code) are to be executed to perform the one or more operations. In at least one example, the first instructions, second instructions, the third instructions, or any combination thereof may be received by the LUT circuit of the memory controller circuit in the integrated circuit device.

At 406, the first instructions are stored in a first memory block (e.g., of a stack of memory blocks (e.g., HBM stack 100, 304). In some scenarios, the first instructions may be stored in more than one memory block of the stack. The first memory block in which the first instructions are stored may be the lowest memory block in the stack, the highest memory block in the stack, or any memory block in between the lowest and highest memory blocks in the stack.

At 408, the second instructions and the third instructions are stored in the memory controller circuit, for example, in the LUT circuit or any other suitable memory within, or conductively coupled to, the integrated circuit device.

At 410, the second instructions are executed (e.g., by the LUT circuit) to transition the computing system from a fully powered state to a partially powered state. In at least one example, executing the second instructions causes the LUT circuit to send a first signal to cause the accelerator and optionally one or more other processors (e.g., other accelerators, CPU, other processing devices) in the computing system to be powered down. In one or more examples, the first signal may be sent to the PMIC (e.g., PMIC 114, 214) in the integrated circuit device or to a separate PMIC in the computing system to power down the accelerator and other processors. The LUT circuit may send a second signal to cause one or more other memory blocks (e.g., memory blocks other than the first memory block where the first instructions are stored) in the stack of memory blocks to be powered down. In one or more examples, the second signal may be sent to a PMIC (e.g., PMIC 114, 214) in the integrated circuit device to power down the one or more other memory blocks without powering down the first memory block.

At 412, once the computing system has transitioned to the partially powered state, the first instructions stored in the first memory block are executed by a low power processor embedded in the integrated circuit device until a second condition is detected.

At 414, the third instructions may be executed (e.g., by the LUT circuit) to enable the detection of the second condition. The second condition may be detected based on the one or more other thresholds, user input, or both associated with one or more other operations to be executed. Examples of conditions that could prompt the transition from a partially powered state to a fully powered state may include one or more of (1) a function or other code executing during the partially powered state finishes, (2) a period for executing the sleepwalking code (e.g., the first instructions) meets or exceeds a time threshold, (3) input was received from a user, or (4) the sleepwalking code directs the memory controller circuit to transition back to a fully powered state. Based on detecting the second condition, the LUT circuit causes the boot firmware, which may be stored in the memory controller circuit, to be executed to transition the computing system from the partially powered state back to the fully powered state. The boot firmware may be executed by the LUT circuit (e.g., LUT circuit 226) in the integrated circuit device, the processor (e.g., embedded processor 112, 212) embedded in the integrated circuit device, or the accelerator (e.g., GPU on processing unit dies 350) or another processor in the computing system, which is given enough power to execute the boot firmware instructions.

The boot firmware in the memory controller circuit may be executed to reboot the accelerator and any other processors in the computing system that were powered down during the partially powered state. Thus, the accelerator and other processors are rebooted and powered up by the boot firmware running in the memory controller circuit of the integrated circuit device.

The boot firmware in the memory controller circuit may be executed further to reboot the one or more other memory blocks in the stack of memory block that were powered down during the partially powered state. Thus, the memory blocks that were previously powered down are rebooted and powered up again.

Once the components of the computing system have been rebooted and powered up, the GPU (or other accelerator) may resume execution of the application utilizing the multiple memory blocks in the memory stack.

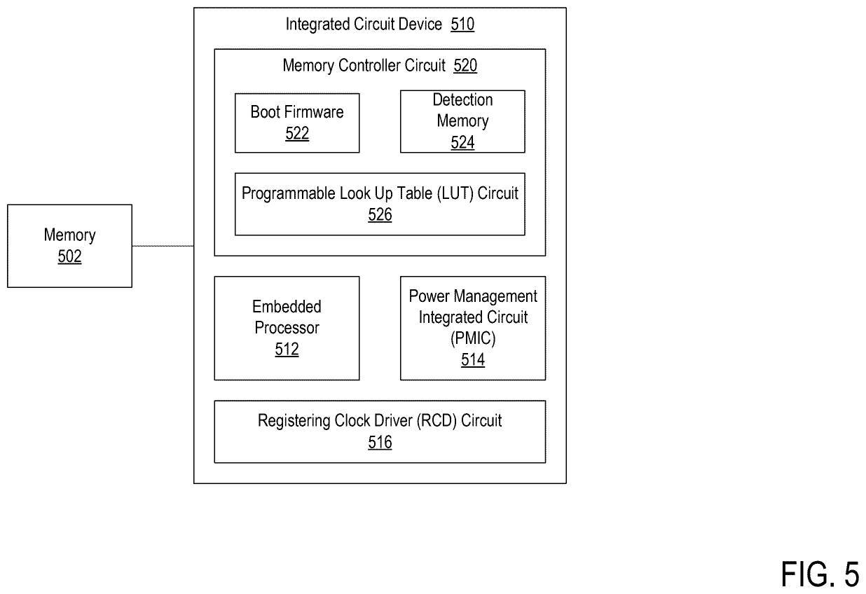

FIG. 5 is a block diagram illustrating an example integrated circuit device 510 conductively coupled to a memory 502, which may include general-purpose memory used in computing systems such as personal computers, desktops, laptops, servers, industrial PCs, industrial desktops, industrial servers, industrial robots, autonomous devices (e.g., drones, eDrones, robots, etc.). Memory 502 includes a plurality of memory components, which are also referred to herein as “memory modules.” In one example, the general-purpose memory includes Dual Inline Memory Module (DIMM), which is a high-speed memory that includes multiple memory components such as dynamic random access memory (DRAM) dies. A DIMM is also referred to herein more generally as a “memory module array,”

In one example, the integrated circuit device 510 includes boot firmware 522, detection memory 524, a programmable lookup table (LUT) circuit 526, an embedded processor 512, a registered clock driver (RCD) 516, and optionally, a power management integrated circuit (PMIC) 514. The boot firmware 522, detection memory 524, and programmable LUT circuit 526 may be generally referred to as a memory controller circuit 520. The integrated circuit device 510 may be configured to, when coupled to a computing system with at least one processor, perform state transition functions between a fully powered state and a partially powered state, memory accesses across the memory modules, some computational functions, and boot functions for components that are powered down in the partially powered state.

The boot firmware 522 can include BIOS, video BIOS, UEFI, or any other suitable firmware that facilitates initialization and configuration of hardware during a boot process. Embedding the boot firmware 522 in the integrated circuit device 510 allows for selected resources of a computing system to be powered up quickly when the computing system is transitioning from a partially powered state to a fully powered state. In one or more examples, the transition may be prompted based on one or more conditions for transitioning to a fully powered state. The one or more conditions for transitioning to a fully powered state may be predefined or dynamically determined as further described below. As previously described herein with reference to boot firmware 222 of FIG. 2, the boot firmware 522 may be configured to perform a full boot or a partial boot, depending on the particular implementation.

The detection memory 524 enables detection and configuration of memory modules (e.g., DRAM dies of memory module arrays) by the boot firmware 522. In one nonlimiting example, the detection memory 524 may include, for example, a serial presence detect (SPD) circuit that stores configuration information about the associated memory modules (e.g., speed, timings, voltage, capacity) and allows the boot firmware 522 (e.g., BIOS, video BIOS, UEFI, etc.) to access and obtain the configuration information to configure the memory settings and initialize the memory channels during the boot process. Because the detection memory 524 and the boot firmware 522 are integrated in the same integrated circuit device 510, the configuration information stored by the detection memory 224 can be accessed quickly to enable a faster transition from a partially powered state to a fully powered state than a typical boot process that might communicate with an SPD circuit over a serial interface bus or other data pathway.

The LUT circuit 526 may include programmable hardware that is programmed with intelligence by a CPU executing an application in the computing system. In at least one example, the CPU (or another processing unit or component in the computing system) may determine that one or more conditions have been met to prompt a transition in the computing system from a fully powered state to a partially powered state. In some examples, the CPU may provide code to the LUT circuit 526 to enable the LUT circuit to determine that one or more conditions have been met to prompt a transition in the computing system from a fully powered state to a partially powered state. Once the one or more conditions have been detected, the CPU may provide code (e.g., executable instructions) to the LUT circuit 526 to enable the LUT circuit to transition the computing system from a fully powered state to a partially powered state, to store sleepwalking code (e.g., which may be executable instructions that are repetitive, simple, routine, non-resource intensive, or the like, or any combination thereof) to be executed during the partially powered state, and to perform memory controller functions for the processor (e.g., embedded processor 512) that executes the sleepwalking code.

The CPU may also provide code to enable the LUT circuit to detect one or more other conditions to prompt a transition in the computing system from the partially powered state to the fully powered state, and to cause embedded boot firmware 522 to be executed based on detecting the one or more other conditions. In other examples, the embedded processor (e.g., embedded processor 512) executing the sleepwalking code may contain hardcoded instructions to detect the one or more other conditions to prompt a transition in the computing system from the partially powered state to the fully powered state and to cause the boot firmware 522 to be executed.

In one example, the LUT circuit 526, which may have functionality that is similar to a small field programmable gate array (FPGA) or other small circuit that is capable of storing and executing instructions received from an accelerator, such as a GPU. The LUT circuit 526 may be configured in a Resistive Random Access Memory (ReRAM). Examples of ReRAM that may be used include, but are not necessarily limited to, 22 nanometer ReRAM or 12 nanometer ReRAM. In other examples, the LUT circuit 526 may be configured in an MRAM, a PCRAM, or any other suitable non-volatile memory.

Embedding an ReRAM-based (or an MRAM-based, PCRAM-based, or any other suitable non-volatile memory-based) LUT circuit 526, boot firmware 522, and detection memory 224 into a single chip (e.g., integrated circuit device 510) for memory 502 (e.g., memory module arrays such as DIMM) allows for selected resources of a computing system to be powered down while code is executing based on detected conditions for transitioning to a partially powered state. The conditions may be predefined or dynamically determined. In at least one example, most (but not all) of the compute and memory resources may be powered down when such resources are not being used and then quickly booted again when the resources are to be used. For example, embedding the memory controller circuit 520 with the ReRAM-based LUT circuit 226, boot firmware 522, and detection memory 524 in the integrated circuit device 510 allows accelerators (e.g., GPU, APU, XPU), if any, and other processors (e.g., CPUs), which may have leaky transistors, and at least some (but not all) of the memory modules of the memory 502 (e.g., DRAM dies in memory module arrays) to be powered down when an application is performing repetitive, simple, or routine functions or tasks, and then powered up again when the instructions to be executed are more complex and may use more compute and memory resources. One or more (or all) other components of a computing system may also be powered down in the partially powered state, or alternatively, one or more (or all) other components may remain powered up in the partially powered state.

The RCD 516 helps manage and distribute clock signals to the memory modules of memory 502. The RCD 516 receives instructions from a CPU of the computing system before sending the instructions to the memory modules. The RCD 516 buffers memory commands (e.g., read, write, etc.) and reduces the strain on a memory controller of the CPU.

The embedded processor 512 may be any suitable processing unit that is embedded in the integrated circuit device 510 and that can execute simple, repetitive, or routine tasks or functions. Embedded processor 512 may be a low power processor that is configured to consume less power than a typical CPU, GPU, or other similar higher power processing units. Such tasks or functions may use the same or less compute resources than a compute resources threshold, the same or less memory resources than a memory resources threshold, the same or less power resources than a power resources threshold, or any combination thereof. In a non-limiting example, the embedded processor 212 may be a small, low power processor including, but not limited to M0 Little, which is an ARM® processor in the Cortex®-M family of processors, or a CPU that implements Reduced Instruction Set Computer (RISC) architecture. In other examples, the embedded processor 512 may be a processing unit such as a microcontroller, which may be integrated in the RCD 516 or the PMIC 514.

Optionally, the PMIC 514 may be included in the integrated circuit device 510. PMIC 514 can manage the power distribution for the memory modules in the memory 502. When the computing system is in a fully powered state, PMIC 514 ensures power delivery to the memory modules of the memory 502. When the computing system transitions to a partially powered state, PMIC 514 may receive a signal from the LUT circuit 526 and, in response to receiving the signal from the LUT circuit 526, selectively power down one or more of the memory modules, while leaving at least one memory module powered up. In at least some scenarios, a single memory module in a single memory module array remains powered up during the partially powered state. It should be noted, however, that in other scenarios, two, three, four, or more memory modules (but not all memory modules) in one or more memory module arrays of the memory 502 remain powered up during the partially powered state. The number of memory modules that remain powered up may be predetermined or dynamically determined depending on the particular code that is to be executed during the partially powered state.

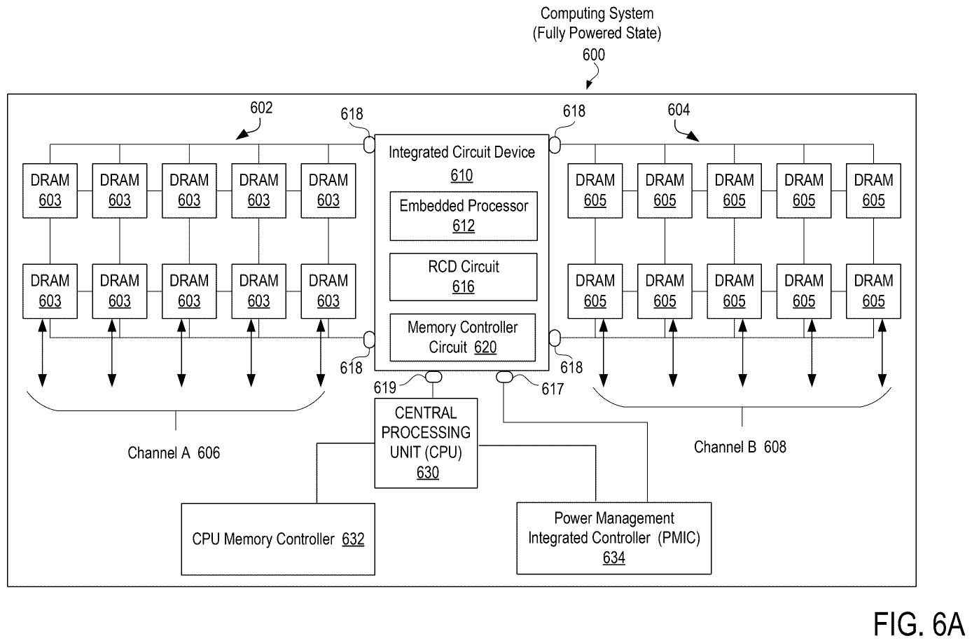

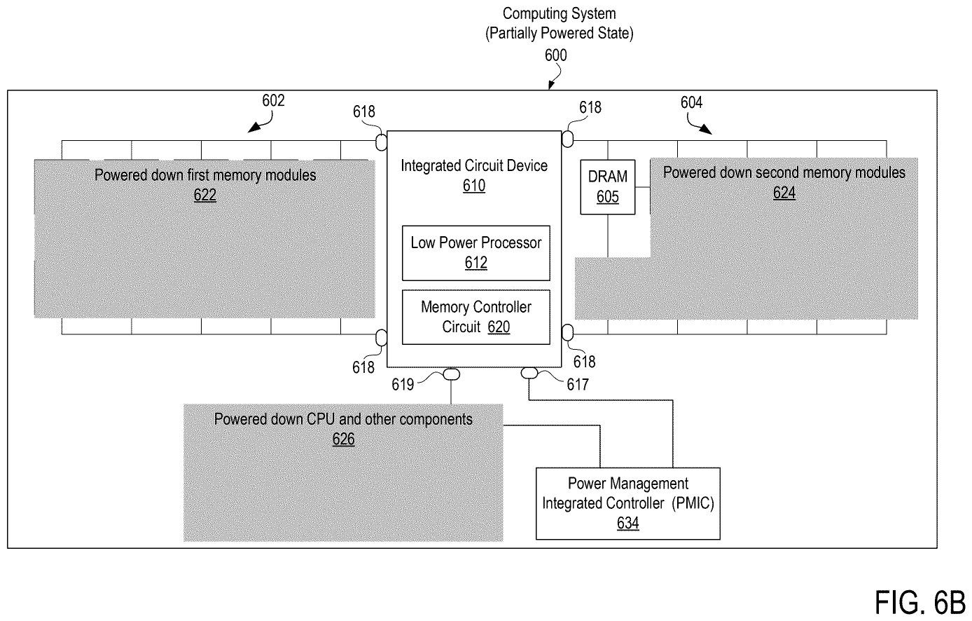

FIGS. 6A and 6B illustrate the transition in a computing system with memory modules and a central processing unit from a fully powered state to a partially powered state according to the present disclosure. FIG. 6A is a top view of a computing system 600 illustrating selected components in a fully powered state according to at least one example. The computing system 600 includes a plurality of memory components including a first memory module array 602 with multiple DRAM dies 603, a second memory module array 604 with multiple DRAM dies 605, and an integrated circuit device 610 may include a plurality of conductive contacts 618 through which the integrated circuit device 610 is conductively coupled to the first memory module array 602 and the second memory module array 604. In one example, the memory module arrays 602 and 604 may be embodied as Dual Inline Memory Modules (DIMMs).

The integrated circuit device 610 may be similar to the integrated circuit device 510 of FIG. 5. Thus, the integrated circuit device 610 may include a memory controller circuit 620, an embedded processor 612, and an RCD circuit 616. The memory controller circuit 620 may include boot firmware (e.g., similar to boot firmware 522 in FIG. 5), detection memory (e.g., similar to detection memory 524 in FIG. 5), and a programmable LUT circuit (e.g., similar to programmable LUT circuit 526 in FIG. 5). Additionally, the integrated circuit device 610 may also include an integrated PMIC (e.g., similar to PMIC 514 of FIG. 5). Alternatively, or in addition to an integrated PMIC, a PMIC 634 may be implemented separately from, but conductively coupled to, a CPU 630 and integrated circuit device 610. The integrated circuit device 610 may include at least one conductive contact 617 to enable the integrated circuit device 610 to be conductively coupled to the PMIC 634.

The computing system 600 may include one or more processors, including CPU 630. In some scenarios, the computing system 600 may also include one or more accelerators (e.g., GPU, APU, XPU). A CPU memory controller 632 is provided to manage and control data flow between the CPU and the memory module arrays 602 and 604 when the computing system is in a fully powered state. The CPU memory controller 632 may be a separate chip in the computing system 600 or may be integrated with CPU 630. The integrated circuit device 610 may include at least one conductive contact 619 to enable the integrated circuit device 610 to be conductively coupled to the CPU 630, an accelerator (e.g., GPU, APU, XPU), a system-on-a-chip (SOC), one or more other processors, one or more other components, or any suitable combination thereof.

Channel A 606 provides a data pathway between the DRAM dies 603 in the first memory module array 602 and the memory controller 632. Channel B 608 provides a data pathway between the DRAM dies 605 in the second memory module array 604 and the CPU memory controller 632 in the computing system.

In FIG. 6A, the computing system 600 is illustrated being in a fully powered state. When the computing system 600 is in a fully powered state, a boot process has previously been completed such that the memory module arrays 602 and 604, the integrated circuit device 610, the CPU 630 and one or more other processors of the computing system 600 (if any), and other components such as the memory controller 632 and the power management integrated controller (PMIC) 634 are powered up. In an example, the computing system 600 may remain in a fully powered state when the computing system 600 is performing tasks or functions that use more than a compute resources threshold, more than a memory resources threshold, more than a power resources threshold, or any suitable combination thereof.

FIG. 6B is a top view of the computing system 600 in a partially powered state. When the computing system 600 is in the fully powered state, an instruction pointer of a processor (e.g., CPU 630) typically points to a next instruction in code to be executed. The instruction may be the start of a set of executable instructions that meet one or more conditions that cause the integrated circuit device 610 to transition the computing system 600 from a fully powered state shown in FIG. 6A to a partially powered state (also referred to herein as a “sleepwalking state”) shown in FIG. 6B. Examples of conditions that could prompt the transition from a fully powered state to a partially powered state may include one or more of (1) a resource (e.g., compute, memory, power) usage level by code to be executed is below a first threshold, (2) a period for the code to be executed exceeds a time threshold, (3) a first number of repeated instructions in the code to be executed exceeds a first number threshold, (4) a second number of repeated sets of instructions in the code to be executed exceeds a second number threshold, (5) input received from a user indicating that code to be executed is to be executed in the sleepwalking state, or (6) the code to be executed is a known function identified a priori as suitable for execution in the sleepwalking state.

Code that is to be executed and that meets one or more conditions including, but not necessarily limited to the conditions outlined above, is also referred to herein as “sleepwalking code.” It should be noted that an application may include one, two, three, or more portions of sleepwalking code that cause the computing system 600 to transition to the partially powered state during which the particular sleepwalking code of the application can be executed. Sleepwalking code may include one or more sets of instructions in an application, a function (e.g., user defined function, library function, function-as-a-service (FaaS) or module invoked by the application), a microservice, code that is generated on the fly by a processor, or a suitable combination thereof. In some examples, sleepwalking code may be generated on the fly by a processor based on particular user inputs, sensor inputs, code, conditions, or a suitable combination thereof.

Generally, sleepwalking code can include any type of instructions that can be executed by a type of processor that can be embedded in the integrated circuit device 610 and that uses less power and other resources than the power and other resources used by the main processor (e.g., CPU 630) executing the application(s) from which the sleepwalking code is derived, generated, or otherwise obtained. In at least some examples, the sleepwalking code may include simple instructions, repetitive instructions, routine instructions, non resource-intensive, or any combination thereof, as previously described herein, for example, with reference to FIG. 3B.

In some examples, the memory controller circuit 620 of the integrated circuit device 610 may ping the CPU 630 to request sleepwalking code. In this example, the integrated circuit device 610 may detect one or more conditions in the computing system 600. When one or more conditions are detected, the integrated circuit device 610 may send a request to the CPU 630 for sleepwalking code and other executable instructions to enable the memory controller circuit 620 (e.g., LUT circuit 526 of FIG. 5) to transition the computing system to a partially powered state.

In other examples, CPU 630 may detect one or more conditions in the computing system that are suitable for transitioning the computing system to the partially powered state. Once the CPU 630 detects the one or more conditions, the CPU 630 may provide the sleepwalking code and other executable instructions to the memory controller circuit 620 to trigger the memory controller circuit 620 (e.g., LUT circuit 526 of FIG. 5) to transition the computing system to the partially powered state.

Once the sleepwalking code and the other executable instructions have been received by the memory controller circuit 620, the memory controller circuit 620 stores the sleepwalking code in one of the memory modules of the memory module arrays (e.g., DRAM die 605 that is visible in FIG. 6B) that is to remain powered up in the partially powered state. The memory controller circuit 620 executes at least some of the other executable instructions received from the GPU to transition the computing system 600 from a fully powered state as shown in FIG. 3A to a partially powered state as shown in FIG. 3B.

During a partially powered state, multiple components in the computing system 600 are powered down and a few components remain powered up to allow the sleepwalking code to be executed. In this example, the components that are powered down during the partially powered state include the memory modules (e.g., DRAM dies 603) of the first memory module array 602, most (but not all) of the memory modules (e.g., DRAM dies 605) in the second memory array 604, and the CPU 630 and memory controller 632. If computing system 600 includes other processors, these other processors may also be powered down in the partially powered state. The powered down components are hidden and referenced as powered down first memory modules 622, powered down second memory modules 624, and powered down CPU and other components 626 in FIG. 6B.

When the computing system 600 is transitioned to the partially powered state, a portion of the integrated memory (e.g., a single DRAM die 605 in the second memory module array 604 that is closest to the integrated circuit device 610) can remain powered up along with the embedded processor 612 (e.g., similar to embedded processor 512 in FIG. 5) embedded in the integrated circuit device 610. The other memory modules in the second memory module array 604 and in the first memory module array 602 can be powered down or shut down, for example, by a PMIC 634 or an integrated PMIC (e.g., similar to PMIC 514 of FIG. 5) of the integrated circuit device 610. In other scenarios, two or more memory modules may remain powered up in the partially powered state. In yet other scenarios, one or more memory modules of the first memory module array 602 remain powered up and one or more memory modules of the second memory module array 604 remain powered up in the partially powered state.

The sleepwalking code can be stored in the memory module that remains powered up (or across two or more memory modules if more than one memory module remains powered up). In the example shown in FIG. 6B, the memory module that is not hidden (e.g., DRAM die 605), remains powered and therefore, the sleepwalking code can be stored in that powered up memory module.

In some examples, as shown in FIG. 6B, the memory module that is closest to the integrated circuit device 610 remains powered up because the close proximity to the integrated circuit device 610 results in shorter electrically conductive pathways for data to travel in the partially powered state. In other examples, however, a different memory module or modules may remain powered up in the partially powered state. Any one or more of the memory modules that remains powered up in the partially powered state may be used to store data, which is inclusive of executable instructions, that is accessed by the integrated circuit device 610 to execute the sleepwalking code.

The memory controller circuit 620 can provide an appropriate signal to cause the CPU 630 and one or more other processors (if any) to be powered down during the partially powered state. For example, a LUT circuit (e.g., LUT circuit 526 in FIG. 5) of the memory controller circuit 620 can provide a signal to cause the PMIC 634 in the computing system to power down the CPU 630 and the one or more other processors (if any). Alternatively, the LUT circuit may provide a signal to an integrated PMIC (e.g., PMIC 514 in FIG. 5) of the integrated circuit device 510 to communicate with the PMIC 634 or other appropriate component in the computing system to power down the CPU 630 and the one or more other processors (if any).

Once the CPU 630 and the selected DRAM dies of the first memory module array 602 and the second memory module array 604 are powered down to allow the computing system 600 to enter the partially powered state, and the sleepwalking code is stored in the powered up memory module (e.g., DRAM die 605), the embedded processor 612 in the integrated circuit device 610 can execute the instructions of the sleepwalking code stored in the powered up memory module (or memory modules if two or more memory modules remain powered up and are used to store at least a portion of the sleepwalking code).

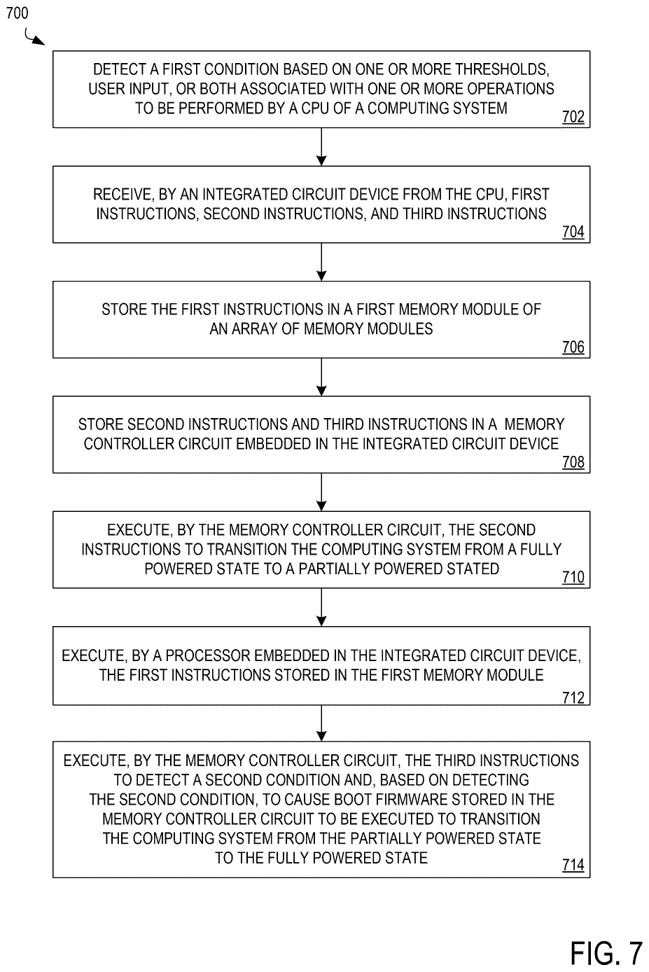

FIG. 7 is an example method 700 for transitioning a computing system (e.g., computing system 600 of FIGS. 6A-6B) between a fully powered state and a partially powered state (or sleepwalking state). The computing system may include a memory controller circuit (e.g., memory controller circuit 520, 620) embedded in an integrated circuit device (e.g., integrated circuit device 510, 610). The integrated circuit device may be conductively coupled to a plurality of memory components (e.g., memory 502 of FIG. 5, memory module arrays 602, 604 of FIGS. 6A-6B) and a CPU (e.g., CPU 630 of FIGS. 6A-6B). In one or more examples, at least some of the operations of method 700 may be performed (or caused by) various components of the integrated circuit device.

At 702, a first condition may be detected based on one or more thresholds or user input or both associated with one or more operations (e.g., in the form of executable instructions, functions, software modules, code generated on the fly, or tasks) to be performed by a CPU of the computing system. Generally, the one or more operations correspond to sleepwalking code, as previously described herein. In some scenarios, the CPU may detect and evaluate the first condition. In other scenarios, the CPU may provide one or more executable instructions to a LUT circuit (e.g., LUT circuit 526) in the integrated circuit device to enable the LUT circuit to detect and evaluate the first condition. In yet other scenarios, another processor or other component in the computing system may detect and evaluate the first condition.

At 704, first instructions, second instructions, and third instructions are received by the integrated circuit device from the CPU. The first, second, and third instructions may be combined or separated in any suitable manner. The first instructions (e.g., sleepwalking code) are to be executed to perform the one or more operations. In at least one example, the first instructions, second instructions, the third instructions, or any combination thereof may be received by the LUT circuit of the memory controller circuit in the integrated circuit device.

At 706, the first instructions are stored in a first memory module of an array of memory modules (e.g., memory module arrays 602, 604). In some scenarios, the first instructions may be stored in more than one memory module of the array of memory modules. The first memory module in which the first instructions are stored may be a memory module that is adjacent to the integrated circuit device, or that is in any other location in the array(s) of memory modules.

At 708, the second instructions and the third instructions are stored in the memory controller circuit, for example, in the LUT circuit or any other suitable memory within, or conductively coupled to, the integrated circuit device.

At 710, the second instructions are executed (e.g., by the LUT circuit) to transition the computing system from a fully powered state to a partially powered state. In at least one example, executing the second instructions causes the LUT circuit to send a first signal to cause the CPU and one or more other processors (if any) (e.g., other processing units, accelerators) in the computing system to be powered down. In one or more examples, the first signal may be sent to the PMIC (e.g., PMIC 514) in the integrated circuit device or to a separate PMIC (e.g., 634) in the computing system to power down the CPU and other processors. The LUT circuit may send a second signal to cause one or more other memory modules (e.g., memory modules other than the first memory module where the first instructions are stored) in the array of memory modules to be powered down. In one or more examples, the second signal may be sent to a PMIC (e.g., PMIC 514) in the integrated circuit device to power down the one or more other memory modules without powering down the first memory module.

At 712, once the computing system has transitioned to the partially powered state, the first instructions stored in the first memory module are executed by a low power processor embedded in the integrated circuit device until a second condition is detected.

At 714, the third instructions may be executed (e.g., by the LUT circuit) to enable the detection of the second condition. The second condition may be detected based on the one or more other thresholds, user input, or both associated with one or more other operations to be executed. Examples of conditions that could prompt the transition from a partially powered state to a fully powered state may include one or more of (1) a function or other code executing during the partially powered state finishes, (2) a period for executing the sleepwalking code meets or exceeds a time threshold, (3) input was received from a user, or (4) the sleepwalking code directs the memory controller circuit to transition back to a fully powered state. Based on detecting the second condition, the LUT circuit causes the boot firmware, which may be stored in the memory controller circuit, to be executed to transition the computing system from the partially powered state back to the fully powered state. The boot firmware may be executed by the LUT circuit (e.g., LUT circuit 526) in the integrated circuit device, the processor (e.g., embedded processor 512, 612) embedded in the integrated circuit device, or the CPU (e.g., CPU 630) or another processor in the computing system, which is given enough power to execute the boot firmware instructions.

The boot firmware in the memory controller circuit may be executed to reboot the CPU and any other processors in the computing system that were powered down during the partially powered state. Thus, the CPU and other processors (if any) are rebooted and powered up by the boot firmware running in the memory controller circuit of the integrated circuit device.

The boot firmware in the memory controller circuit may be further executed to reboot the one or more other memory modules in the memory module arrays that were powered down during the partially powered state. Thus, the memory modules that were previously powered down are rebooted and powered up again.

Once the components of the computing system have been rebooted and powered up, the CPU (or other processors) may resume execution of the application utilizing the multiple memory modules in the first memory module array and the second memory module array.

Examples of computer architecture that may be used to implement subject matter associated with memory controller circuitry to enable a partially powered state in a computing system as disclosed herein is described below. Computing systems including at least one processor (e.g., CPU, GPU, etc.) and memory that includes multiple memory components (e.g., layers, memory blocks, modules or other storage components) is generally suitable to implement the subject matter disclosed herein. Computing systems known in the art may include, but are not limited to, desktop personal computers, laptops, notebooks, ultrabooks, tablets, smartphones, cell phones, mobile computing devices, servers, embedded systems, gaming consoles, smart televisions (TVs), wearables, vehicle computing devices (e.g., in automobiles, airplanes, trains, ships, boats, hovercraft, etc.), set-up boxes, streaming devices, augmented reality (AR) and virtual reality (VR) headsets, smart home devices, networking devices, edge devices, Internet of Things (IoT) devices, routers, switches, and hubs. Additionally, other computing system designs in which the subject matter herein may be implemented include autonomous robotic systems such as drones, eDrones, robotic pets (e.g., eDogs), eFish, humanoid robots, industrial personal computers, and industrial desktop computers. Generally, suitable computer architectures to implement examples disclosed herein (e.g., microelectronic assemblies 300, integrated circuit devices 101, 201, 301, 510, 610, computing systems 600) include, but are not limited to the computing system of FIG. 8.

FIG. 8 is a block diagram of an example computing system 800 that may be used in accordance with any of the examples disclosed herein. For example, computing system 800 illustrates a computer architecture that may be used to implement any of the systems disclosed herein (e.g., HBM stack 100, integrated circuit device 101, 201, 301, 510, 610, microelectronic assembly 300, computing system 600) or any suitable combination thereof.

Computing system 800 includes one or more processors 802, memory 804, a memory controller 806, a storage device 808, input/output device 810, a display device 812, audio/visual components 816, communication components 818, and an antenna 820.

One or more of processors 802 may include processing devices or processing units that include suitable hardware circuitry to enable the execution of instructions and the ability to perform calculations to carry out the operations of software, firmware, hardware, or any suitable combination thereof. Activities disclosed in this Specification may be achieved by the operations carried out by one or more of the processors 802. Processors 802 may be embodied as single-core processing devices or multi-core processing devices, or some combination thereof.

Nonlimiting examples of possible types of processing devices include a central processing unit (CPU), a microprocessor, embedded processor, a digital signal processor (DSP), a system-on-a-chip (SoC), a co-processor, a low power processor (e.g., M0 Little, which is an ARM® processor in the Cortex®-M family of processors), microcontroller, any type of accelerator (XPU), or any other processing device to execute code. Example accelerators can include, but are not limited to a graphics processing unit (GPU), an accelerated processing unit (APU), a visual processing unit (VPU), a deep learning processor (DLP), a neural network processing unit (NPU), a general purpose graphics processing unit (GPGPU), an inference accelerator, an application-specific integrated circuit (ASIC), or a field-programmable gate array (FPGA). One or more of the processors 802 may perform specialized processing tasks (e.g., graphics processing by GPUs, machine learning by DLPs, vision processing by VLPs, and the like). One or more of the processors 802 may perform specialized processing tasks on behalf of one or more other processing devices such as CPUs or GPUs, for example.

One or more of the processors 802 may be a small, low-power processor for performing non resource-intensive operations (e.g., repetitive operations, repetitive sets of operations, or simple operations or a combination thereof performed for at least a threshold period of time). One example includes M0 Little, which is an ARM® processor in the Cortex®-M family of processors. Other nonlimiting examples include a microcontroller or an FPGA. One or more low-power processors may be integrated with memory, separate from the memory but conductively coupled to the memory, or a combination thereof. In some examples, a low power processor may be embedded in a semiconductor die, which may be part of an integrated circuit device (e.g., integrated circuit device 101, 201, 301, 510, 610) in computing system 800.

Generally, memory 804 includes one or more memory devices that store data to be manipulated by, generated by, or otherwise used by processors 802 when performing operations, including operations associated with enabling a partially-powered state in a computing system as disclosed herein. Memory 804 may include any form of volatile memory or non-volatile memory including, without limitation, random access memory (RAM), dynamic random access memory (DRAM), static random access memory (SRAM), ferroelectric random access memory (FeRAM), read-only memory (ROM), erasable programmable read-only memory (EPROM), electrically erasable read-only memory (EEPROM), flash memory, removable media, optical media, magnetic media (e.g., tape drives), any other suitable memory components, or any suitable combination thereof. Memory 804 may include one or more memory devices within the computing system, one or more memory devices separate from but communicatively coupled to the computing system, or a suitable combination thereof.

A memory hierarchy in computing system 800 may include one or more levels of cache (e.g., level one (L1), level two (L2), level three (L3), other levels of cache or combinations thereof). The cache levels may be within, close to, or accessible by the one or more processors 802. For example, some cache may be close to or within a core of one processor and accessible by only that core. Another cache level may be close to a core of a processor and shared with (and therefore, accessible by) another core of the same processor or a different processor.

Memory devices of memory 804 may include one or more memory components (e.g., memory modules, memory layers, memory blocks, or the like) of system memory coupled to the processors 802 through one or more memory controllers 806. Generally, the system memory is some form of volatile memory (e.g., DRAM, RAM, SRAM, etc.). A portion or more of the system memory may be dedicated to a particular processing device. A portion or more of the system memory may be shared across one or more of the processors 802 in the computing system.

In some examples, memory devices include multiple memory components. A plurality of memory components of a memory device may be arranged in any suitable form including, but not limited to a layered stack (e.g., high bandwidth memory (HBM) stack of memory layers or memory blocks) or a memory array (e.g., Dual Inline Memory Modules (DIMM)). In some examples, computing system 800 includes a single type of memory (e.g., one or more layered stacks or one or more memory arrays). In some other examples, computing system 800 includes a combination of types of memory (e.g., one or more layered stacks and one or more memory arrays).

Memory controllers 806 are hardware interfaces including hardware components that are integrated with, or external to, the processors 802. Memory controllers 806 can manage communication between processors 802 (e.g., a CPU, a GPU) and memory (e.g., DRAM). In addition to memory controllers 806, other memory controller circuitry may include, but is not necessarily limited to memory management units (MMUs), translation lookaside buffers (TLBs), load and store buffers, an address generation unit (AGU), an address decoder, and more. The memory controller circuitry may include electrical components, optical components, quantum components, semiconductor devices, logic elements, or any suitable combination thereof, to perform operations to read/load from memory and write/store to memory. Data may be read/loaded from the closest memory where it is stored (e.g., cache memory, system memory, storage devices, or remote memory). In addition, data may be written/stored to cache before being written/stored in system memory or a storage device.

In one or more examples, a memory device with multiple memory components may be integrated with, or may be conductively coupled to, an integrated circuit device (e.g., integrated circuit device 101, 201, 301, 510, 610) to manage memory accesses of memory components and to enable transitions between a fully powered state and a partially powered state. The integrated circuit device may include an embedded memory controller circuit (e.g., memory controller circuit 120, 220, 320, 520, 620) to enable transitions between a fully powered state and partially powered state for the computing system 800, and an embedded processor (e.g., embedded processor 112, 212, 512, 612) to enable execution of sleepwalking code when the computing system 800 is in the partially powered state. Computing system 800 may include one or more memory devices of the same type (e.g., HBM memory stack(s) or DIMM array(s)) or multiple memory devices of different types (e.g., one or more HBM memory stacks and one or more DIMM arrays).

Storage device 808 generally includes non-volatile memory and may include any suitable characteristics described above with respect to memory 804. Generally, storage device 808 can have higher capacity and slower speed than memory 804. Thus, storage device 808 may be typically (although not always exclusively) used for longer term storage. In some examples, storage device 808 includes one or more non-volatile storage devices such as hard disk drives (HDDs), solid state drives (SSDs), removable storage devices (e.g., flash drives), other media (e.g., transitory machine readable media, non-transitory machine readable media), or any suitable combination thereof.

The display device 812 and input/output devices 810 may be interfaces that enable a human user to interact with the computing system 800. The display device 812 may include any suitable screen or monitor that visually presents data in the form of text, images, video, graphical information, other data or information, or any combination thereof. The display device 812 may be integrated within the computing system (e.g., laptop screen, tablet screen, smart phone screen, etc.) or may be an external device (e.g., desktop monitor, external monitor, etc.) that is communicatively connected to the computing system 800. Data may be generated by the one or more processors 802 or received as input (e.g., from a human user via an input device) and provided for display on the display device 812. In some scenarios, one or more additional display devices may be integrated within, or communicatively connected to, the computing system 800. Input/output devices 810 may be interfaces to enable communications from and to a human user. Input/output devices 810 may include, without limitation, a keyboard, a mouse, touchscreen on a display device (e.g., display device 812), trackball, or the like.

Power components 814 manage the conversion, distribution, and regulation of electrical power for various subsystems of the computing system 800. Power components 814 may include one or more power supplies to convert AC power to DC power, voltage regulators to step down voltage from the power supply unit, power management integrated circuits (PMICs) to control power sequencing and delivery, batteries (e.g., to provide the main source of power to computing system 800 or to provide an auxiliary power source such as to retain BIOS or UEFI settings). In some examples, computing system 800 includes multiple PMICs, where a given PMIC is configured to convert and distribute power from the battery or other power supply to particular components (e.g., memory components of a memory device or processors or any other type of component or group of components) in the computing system 800.

Audio/visual components 816 may include audio/visual devices (e.g., web camera, microphone, speaker). Audio/visual components 816 may be integrated or built into the computing system 800 or separate from and communicatively coupled to the computing system 800.

Communication components 818 may include hardware software, firmware, or suitable combination thereof to facilitate communications via a network 830. For example, communication components 818 may include one or more network interface controllers, network drivers and firmware, modem, router, switch, adapters, or other suitable components.

The network 830 can include any type or topology of networks and represents a series of points or nodes of interconnected communication pathways for receiving and sending network communications. Network 830 offers a communicative interface between nodes (e.g., computing system 800, one or more remote devices also coupled to the network 830 such as remote device 832) and may be configured as any local area network (LAN), virtual local area network (VLAN), wide area network (WAN), Internet, Intranet, Extranet, virtual private network (VPN), cloud network, any other appropriate architecture or system that facilitates communications in a network environment, or any suitable combination thereof. Network 830 can use any suitable technologies for communication including wireless (e.g., 3G/4G/5G/nG network, Wireless Fidelity (Wi-Fi), worldwide interoperability for microwave access (WiMax), radio-frequency identification (RFID), near field communication (NFC), Bluetooth, or the like), wired (e.g., ethernet, fiber optic cables, powerlines, T1 lines, etc.), or a suitable combination thereof.

An antenna 820 may be provided in the computing system 800 to facilitate at least some wireless communications. For example, antenna 820 may be provided to enable sending and receiving wireless communications, including receiving AM or FM radio transmissions.

In one example, network 830 can be used to communicate with a remote device 832, which may be separate from but communicatively coupled to the computing system 800 via the network 830. The remote device 832 may be operated by a user 822, which may be human or electronic (e.g., robot or other automation). The computing system 800 may receive user input via remote device 832.

As used herein, the term “logic” may refer to hardware (e.g., circuitry), firmware, software, or any combination thereof configured to perform one or more functions. Logic may be implemented using digital circuits such as combinational logic gates, sequential circuits, programmable logic devices, application-specific integrated circuits (ASICs), field-programmable gate arrays (FPGAs), microprocessors, or microcontrollers. In some embodiments, logic may also include software or firmware instructions stored in memory and executed by one or more processing units.

As used herein, the term “integrated circuit device” and “integrated circuit component” refer to a packaged or unpacked integrated circuit product. A packaged integrated circuit device comprises one or more integrated circuit dies mounted on a package substrate with the integrated circuit dies and package substrate encapsulated in a casing material, such as metal, plastic, glass, or ceramic. In one example, a packaged integrated circuit device contains one or more processor units mounted on a substrate (e.g., directly or via an interposer) with an exterior surface of the substrate comprising a solder ball grid array (BGA). In one example of an unpackaged integrated circuit device, a single monolithic integrated circuit die comprises solder bumps attached to contacts on the die. The solder bumps allow the die to be directly or indirectly attached to a printed circuit board, to other integrated circuit dies, to an interposer, to a substrate, or the like, or any suitable combination thereof. An integrated circuit device can comprise one or more of any computing system component described or referenced herein or any other computing system component, such as a processing device, processor unit (e.g., system-on-a-chip (SoC), processor core, graphics processor unit (GPU), accelerator, chipset processor), I/O controller, memory, or network interface controller.

With regard to this specification, unless expressly stated to the contrary, use of the phrases “at least one of” and “one or more than” refers to any combination of the named elements, conditions, components, devices, units, controllers, processors, resource usage levels, signals, settings, commands, or other items. For example, “at least one of X, Y, and Z” is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Additionally, the phrase “X or Y” should be understood to mean “X, Y, or both X and Y.” The singular terms “a,” “an,” and “the” are intended to encompass their plural counterparts as well, unless it is clear from the context that a different interpretation is intended.

Unless expressly stated to the contrary, the terms “first,” “second,” “third,” and the like can reference objects that have one or more similar characteristics and indicate the different objects. For example, a “first memory component” and a “second memory component” may refer to a DRAM die in an HBM stack and a DRAM module in a DIMM array, respectively. Alternatively, the terms “first,” “second,” “third,” and the like can reference a similar element and indicate different instances of the like elements that are referenced. For example, a “first memory component” and a “second memory component” may refer to two distinct DRAM dies in an HBM stack or two distinct DRAM modules in a DIMM array. Unless expressly stated to the contrary, such adjectives are not intended to imply elements so referenced are required to be in a particular sequence, either temporally or spatially, in a particular ranking, in a particular hierarchy, or any other particular manner.

As used herein, the phrase “conductively coupled” and “electrically coupled” refer to the presence of one or more electrically conductive pathways between components that are recited as being so coupled. Electrically conductive pathways correspond to electrically conductive traces and vias that are capable of conducting electrical signals when a microelectronic assembly (e.g., microelectronic assemblies 300, integrated circuit devices 101, 201, 301, 510, 610) is in operation. The electrically conductive pathways are to conduct electrical signals within electrically active regions of the microelectronic assembly. The electrically conductive pathways include, for example, through silicon vias (TSVs), traces, and any electrically conductive pathways to and from any active or passive components.

Certain terminology may also be used herein for the purpose of reference only, and thus are not intended to be limiting. For example, terms such as “upper,” “lower,” “above,” “below,” “bottom,” and “top” refer to directions in the Figures to which reference is made. Such terms describe the orientation, location, or both orientation and location of, without limitation, circuits, layers, components or portions of components, devices, dies, blocks, modules, processors within a consistent but arbitrary frame of reference, which is made clear by reference to the text and the associated Figures describing, without limitation, circuits, layers, components or portions of components, devices, dies, blocks, modules, processors under discussion. Such terminology may include the words specifically mentioned above, derivatives thereof, and words of similar import.

The following examples pertain to the subject matter disclosed herein. In accordance with this specification, a system, apparatus, method, machine readable storage media, or a combination thereof, can include one or a combination of the following examples.

The following examples pertain to embodiments in accordance with this specification. Example A1 provides an integrated circuit device comprising a first conductive contact to be conductively coupled to a first memory component and a second memory component of a plurality of memory components in a computing system, a second conductive contact to be conductively coupled to a first processing unit in the computing system, and a memory controller circuit to cause first executable instructions received from the first processing unit to be stored in the first memory component and to cause the computing system to transition from a first power state to a second power state, and during the second power state, the second memory component and the first processing unit are to be powered down and the first memory component is to be powered up. The integrated circuit device of Example A1 further comprises an embedded processor to execute the first executable instructions.

Example A2 comprises the subject matter of Example A1, and the memory controller circuit is to cause the computing system to transition to the second power state based on executing second executable instructions received from the first processing unit.

Example A3 comprises the subject matter of Example A2, and the memory controller circuit includes a programmable lookup table to execute the second executable instructions.

Example A4 comprises the subject matter of any one of Examples A2-A3, and the memory controller circuit is further to send a first signal to cause the first processing unit to be powered down based on executing the second executable instructions.

Example A5 comprises the subject matter of any one of Examples A1-A4, and further includes a power management integrated circuit to receive a second signal from the memory controller circuit indicating that the computing system is to transition to the second power state, and to power down the second memory component without powering down the first memory component based on receiving the second signal.

Example A6 comprises the subject matter of Example A5, and the power management integrated circuit is to further power down one or more other memory components of the plurality of memory components without powering down the first memory component.

Example A7 comprises the subject matter of any one of Examples A1-A6, and the memory controller circuit further includes non-volatile memory to store one or more firmware instructions that, when executed by at least one processing unit, cause the at least one processing unit to boot the first processing unit and cause the second memory component to be powered up.

Example A8 comprises the subject matter of Example A7, and the memory controller circuit further includes a programmable lookup table circuit to execute third executable instructions received from the first processing unit to detect a condition and to cause the one or more firmware instructions to be executed based on detecting the condition.

Example A9 comprises the subject matter of Examples A7, and the embedded processor is further to execute fourth executable instructions detect a condition and cause the one or more firmware instructions to be executed based on detecting the condition.

Example A10 comprises the subject matter of any one of Examples A8-A9, and the condition comprises one or more of an execution of the first executable instructions finishes, a period for executing the first executable instructions meets a time threshold, or second input is received from a user.

Example A11 comprises the subject matter of any one of Examples A7-A10, and the one or more firmware instructions comprise a Basic Input/Output System (BIOS), a video BIOS, or a Unified Extensible Firmware Interface (UEFI).

Example A12 comprises the subject matter of any one of Examples A1-A11, and further comprising serial presence detect memory to store configuration information associated with the first memory component and the second memory component.

Example A13 comprises the subject matter of any one of Examples A1-A12, and further comprising a registering clock driver circuit to send one or more memory access commands to the first memory component to access the first executable instructions.

Example A14 comprises the subject matter of any one of Examples A1-A12, and the plurality of memory components includes a stack of memory blocks of high bandwidth memory (HBM) and the first processing unit is a graphics processing unit (GPU).

Example A15 comprises the subject matter of any one of Examples A1-A13, and the plurality of memory components includes an array of dual-inline memory modules (DIMM) and the first processing unit is a central processing unit (CPU).

Example S1 provides a system that includes a memory including at least a first memory component and a second memory component, a first processing unit, and an integrated circuit device conductively coupled to the first memory component, the second memory component, and the first processing unit, and when the memory and the first processing unit are powered up, the integrated circuit device is to cause the second memory component and the first processing unit to be powered down without powering down the first memory component, store first executable instructions received from the first processing unit in the first memory component, and execute the first executable instructions stored in the first memory component.

Example S2 comprises the subject matter of Example S1, and the integrated circuit device is to cause the second memory component and the first processing unit to be powered down based on executing second executable instructions received from the first processing unit.

Example S3 comprises the subject matter of Example S2, and the integrated circuit device is further to, based on executing the second executable instructions, power down one or more other memory components of the memory without powering down the first memory component.

Example S4 comprises the subject matter of any one of Examples S2-S3, and the integrated circuit device includes a programmable lookup table circuit to execute the second executable instructions.

Example S5 comprises the subject matter of any one of Examples S2-S4, and the integrated circuit device is further to send a first signal to cause the first processing unit to be powered down based on executing the second executable instructions.

Example S6 comprises the subject matter of any one of Examples S2-S5, and the first processing unit is to provide the first executable instructions and the second executable instructions to the integrated circuit device based on detecting a first condition.

Example S7 comprises the subject matter of Example S6, and the first condition comprises one or more of a first resource usage level of the first executable instructions based on a first threshold, a period for executing the first executable instructions based on a second threshold, a first number of repeated instructions in the first executable instructions based on a third threshold, a second number of repeated sets of instructions in the first executable instructions based on a fourth threshold, or first input received from a user.

Example S8 comprises the subject matter of any one of Examples S6-S7, and the integrated circuit device further includes a programmable lookup table circuit and a power management integrated circuit to receive a second signal from the programmable lookup table circuit indicating a detection of the first condition and to power down the second memory component in response to receiving the second signal.

Example S9 comprises the subject matter of any one of Examples S1-S8, and the integrated circuit device further includes non-volatile memory to store one or more firmware instructions that, when executed by at least one processing unit, cause the at least one processing unit to boot the first processing unit and cause the second memory component to be powered up.

Example S10 comprises the subject matter of Example S9, and the integrated circuit device further includes a programmable lookup table circuit to execute third executable instructions to detect a second condition and cause the one or more firmware instructions to be executed based on detecting the second condition.

Example S11 comprises the subject matter of Example S10, and the second condition comprises one or more of an execution of the first executable instructions finishes, a period for execution of the first executable instructions meets a time threshold, or second input is received from a user.

Example S12 comprises the subject matter of Example S9, and the integrated circuit device further includes an embedded processor to execute the first executable instructions stored in the first memory component.

Example S13 comprises the subject matter of Example S12, and the embedded processor is further to execute fourth executable instructions to detect a second condition and cause the one or more firmware instructions to be executed based on detecting the second condition.

Example S14 comprises the subject matter of any one of Examples S9-S13, and the one or more firmware instructions comprise a Basic Input/Output System (BIOS), a video BIOS, or a Unified Extensible Firmware Interface (UEFI).

Example S15 comprises the subject matter of any one of Examples S1-S14, and the integrated circuit device further includes serial presence detect memory to store configuration information associated with the first memory component and the second memory component.

Example S16 comprises the subject matter of any one of Examples S1-S15, and the integrated circuit device further includes a registering clock driver circuit to send one or more memory access commands to the first memory component to access the first executable instructions.

Example S17 comprises the subject matter of any one of Examples S1-S16, and further includes a central processing unit (CPU) conductively coupled to the integrated circuit device, and the integrated circuit device is further to send one or more other signals to cause the CPU to be powered down based on executing second executable instructions received from the first processing unit.

Example S18 comprises the subject matter of any one of Examples S1-S15 or S17, and the memory includes a stack of memory blocks of high bandwidth memory (HBM) and the first processing unit includes a graphics processing unit (GPU).

Example S19 comprises the subject matter of any one of Examples S1-S19, and the memory includes an array of dual-inline memory modules (DIMM) and the first processing unit includes a central processing unit (CPU).

Example M1 provides a method including receiving from a first processing unit, by a memory controller circuit in an integrated circuit device conductively coupled to a first memory component and a second memory component, first executable instructions and second executable instructions, executing the second executable instructions to send a first signal to cause the first processing unit to be powered down, send a second signal to cause the second memory component to be powered down without powering down the first memory component, and store the first executable instructions in the first memory component. The method of Example M1 further includes executing, by an embedded processor in the integrated circuit device, the first executable instructions stored in the first memory component.

Example M2 comprises the subject matter of Example M1, and further including detecting, by the integrated circuit device, a condition associated with the first executable instructions, and executing, based on detecting the condition, boot firmware instructions stored in nonvolatile memory of the memory controller circuit, and executing the boot firmware instructions includes booting the first processing unit and sending a third signal to power up the second memory component.

Example M3 comprises the subject matter of Example M2, and the condition is detected by either a programmable lookup table in the integrated circuit device or an embedded processor in the integrated circuit device.

Example M4 comprises the subject matter of any one of Examples M2-M3, and executing the boot firmware instructions includes obtaining information related to the second memory component from a serial presence detect circuit in the integrated circuit device and configuring one or more memory settings for the second memory component.

Example M5 comprises the subject matter of any one of Examples M1-M4, and further includes sending, by a registering clock driver circuit, one or more memory access commands to the first memory component to access the first executable instructions.

1. An integrated circuit device comprising:
a first conductive contact to be conductively coupled to a first memory component and a second memory component of a plurality of memory components in a computing system;
a second conductive contact to be conductively coupled to a first processing unit in the computing system;
a memory controller circuit to:
cause first executable instructions received from the first processing unit to be stored in the first memory component; and
cause the computing system to transition from a first power state to a second power state, wherein during the second power state, the second memory component and the first processing unit are to be powered down and the first memory component is to be powered up; and
an embedded processor to execute the first executable instructions.

2. The integrated circuit device of claim 1, wherein the memory controller circuit is to cause the computing system to transition to the second power state based on executing second executable instructions received from the first processing unit.

3. The integrated circuit device of claim 2, wherein the memory controller circuit includes a programmable lookup table to execute the second executable instructions.

4. The integrated circuit device of claim 2, wherein the memory controller circuit is further to send a first signal to cause the first processing unit to be powered down based on executing the second executable instructions.

5. The integrated circuit device of claim 1, further comprising:
a power management integrated circuit to:
receive a second signal from the memory controller circuit indicating that the computing system is to transition to the second power state; and
power down the second memory component without powering down the first memory component based on receiving the second signal.

6. The integrated circuit device of claim 5, wherein the power management integrated circuit is to further power down one or more other memory components of the plurality of memory components without powering down the first memory component.

7. The integrated circuit device of claim 1, wherein the memory controller circuit further includes:
non-volatile memory to store one or more firmware instructions that, when executed by at least one processing unit, cause the at least one processing unit to:
boot the first processing unit; and
cause the second memory component to be powered up.

8. The integrated circuit device of claim 7, wherein the memory controller circuit further comprises:
a programmable lookup table circuit to:
execute third executable instructions received from the first processing unit to detect a condition; and
cause the one or more firmware instructions to be executed based on detecting the condition.

9. The integrated circuit device of claim 7, wherein the embedded processor is further to:
execute fourth executable instructions detect a condition; and
cause the one or more firmware instructions to be executed based on detecting the condition.

10. The integrated circuit device of claim 9, wherein the condition comprises one or more of an execution of the first executable instructions finishes, a period for executing the first executable instructions meets a time threshold, or second input is received from a user.

11. The integrated circuit device of claim 7, wherein the one or more firmware instructions comprise a Basic Input/Output System (BIOS), a video BIOS, or a Unified Extensible Firmware Interface (UEFI).

12. The integrated circuit device of claim 1, wherein the plurality of memory components includes a stack of memory blocks of high bandwidth memory (HBM) and the first processing unit includes a graphics processing unit (GPU), or wherein the plurality of memory components includes an array of Dual Inline Memory Modules (DIMM) and the first processing unit includes a central processing unit (CPU).

13. A system comprising:
a memory including at least a first memory component and a second memory component;
a first processing unit; and
an integrated circuit device conductively coupled to the first memory component, the second memory component, and the first processing unit, wherein when the memory and the first processing unit are powered up, the integrated circuit device is to:
cause the second memory component and the first processing unit to be powered down without powering down the first memory component;
store first executable instructions received from the first processing unit in the first memory component; and
execute the first executable instructions stored in the first memory component.

14. The system of claim 13, wherein the integrated circuit device is to cause the second memory component and the first processing unit to be powered down based on executing second executable instructions received from the first processing unit.

15. The system of claim 14, wherein the integrated circuit device is further to send a first signal to cause the first processing unit to be powered down based on executing the second executable instructions.

16. The system of claim 14, wherein the first processing unit is to provide the first executable instructions and the second executable instructions to the integrated circuit device based on detecting a first condition.

17. The system of claim 16, wherein the first condition comprises one or more of a first resource usage level of the first executable instructions based on a first threshold, a period for executing the first executable instructions based on a second threshold, a first number of repeated instructions in the first executable instructions based on a third threshold, a second number of repeated sets of instructions in the first executable instructions based on a fourth threshold, or first input received from a user.

18. The system of claim 13, wherein the integrated circuit device includes:
non-volatile memory to store one or more firmware instructions that, when executed by at least one processing unit, cause the at least one processing unit to:
boot the first processing unit; and
cause the second memory component to be powered up.

19. A method comprising:
receiving from a first processing unit, by a memory controller circuit in an integrated circuit device conductively coupled to a first memory component and a second memory component, first executable instructions and second executable instructions;
executing the second executable instructions to:
send a first signal to cause the first processing unit to be powered down;
send a second signal to cause the second memory component to be powered down without powering down the first memory component; and
store the first executable instructions in the first memory component; and
executing, by an embedded processor in the integrated circuit device, the first executable instructions stored in the first memory component.

20. The method of claim 19, further comprising:
detecting, by the integrated circuit device, a condition associated with the first executable instructions; and
executing, based on detecting the condition, boot firmware instructions stored in non-volatile memory of the memory controller circuit, wherein executing the boot firmware instructions includes:
booting the first processing unit; and
sending a third signal to power up the second memory component.
